(19) United States
(12) Patent Application Publication
(10) Pub. No.: US 2026/0358473 A1
(43) Pub. Date: Nov. 12, 2026

(54) INTERFERENCE HANDLING IN JOINT COMMUNICATION AND SENSING (JCAS) SYSTEMS

(71) Applicant: Intel Corporation, Santa Clara, CA (US)

(72) Inventors: Fatemeh Hamidi-Sepehr, San Jose, CA (US); Thushara Hewavithana, Tempe, AZ (US); Mark Lehne, Hillsboro, OR (US); Qian Li, Portland, OR (US); Debdeep Chatterjee, San Jose, CA (US)

(73) Assignee: Intel Corporation, Santa Clara, CA (US)

(21) Appl. No.: 19/118,555

(22) PCT Filed: Nov. 6, 2023
(86) PCT No.: PCT/US2023/078815

§ 371 Date: Apr. 4, 2025

Related U.S. Application Data
(60) Provisional application No. 63/423,635, filed on Nov. 8, 2022.

(51) Int. Cl. G01S 7/41; G01S 13/08; G01S 13/58; H04L 5/00

(52) U.S. Cl. CPC G01S 7/41; G01S 13/08; G01S 13/58; H04L 5/0062; H04L 5/0094

(57) ABSTRACT

Techniques for managing interference in joint communication and sensing (JCAS) systems are described. In one embodiment, a sensing entity maps a first set of sensing modulated symbols to time and frequency resources of an orthogonal frequency division multiplexing (OFDM) resource grid, wherein the first set of sensing modulated symbols are mapped to a set of comb-structured subcarriers over one or more consecutive OFDM symbols to reduce interference with a second set of modulated symbols within a same frequency bandwidth, and encodes a sensing signal comprising the mapped first set of sensing modulated symbols. Other embodiments are described and claimed.

### RELATED CASE

This application claims the benefit of and priority to previously filed U.S. Provisional Patent Application Ser. No. 63/423,635, filed Nov. 8, 2022, entitled “INTERFERENCE HANDLING IN JOINT COMMUNICATION AND SENSING (JCAS) SYSTEMS”, which is hereby incorporated by reference in its entirety.

### BACKGROUND

Joint communication and sensing (JCAS) is one of the key technologies envisioned for 6G communication systems to support operation of both communication and sensing functions and potentially improve the mutual performance with coordinated operation of the two functions. JCAS presents several unique challenges and design considerations. Regarding the coexistence of communication and sensing operations, a key challenge is to have a flexible design that can operate under different communication and sensing performance and hardware/complexity tradeoffs. Sensing signal resource attributes and structure, as well as resource multiplexing between sensing and communication services, are important parts of this challenge.

### BRIEF DESCRIPTION OF THE DRAWINGS

FIG. 1 illustrates an example of sensing and communication blocks in accordance with one embodiment.

FIG. 2 illustrates an example of inter-cell interference for sensing in accordance with one embodiment.

FIG. 3 illustrates an example positioning reference signal (PRS) with three base stations in accordance with one embodiment.

FIGS. 4A-4D illustrate examples of downlink comb-N PRS transmission patterns for PRS resources in accordance with one embodiment.

FIG. 5 illustrates an example of range bin estimation for different target positions beyond inter-symbol interference-free range in accordance with one embodiment.

FIG. 6 illustrates an example of orthogonal signal allocation using comb-3 among three neighboring cells in accordance with one embodiment.

FIG. 7 illustrates a staggered comb-2 frequency domain resource structure over two consecutive orthogonal frequency division multiplexing (OFDM) symbols in accordance with one embodiment.

FIG. 8 illustrates an example of zero power channel state information reference signal (CSI-RS) and non-zero power CSI-RS in accordance with one embodiment.

FIGS. 9A-9C illustrate downlink PRS muting options in accordance with one embodiment.

FIG. 10 illustrates an interference field of view of a beam coming from one base station for a second base station in accordance with one embodiment.

FIG. 11 illustrates the received interference power of one base station due to a beam from another base station versus azimuth arriving angle in accordance with one embodiment.

FIG. 12 illustrates spatial multiplexing of sensing signals using the interference field of view concept in accordance with one embodiment.

FIG. 13 illustrates code domain multiplexing to mitigate inter-cell interference in accordance with one embodiment.

FIG. 14 illustrates user equipment in accordance with one embodiment.

FIG. 15 illustrates a base station in accordance with one embodiment.

FIG. 16 illustrates a logic flow in accordance with one embodiment.

FIG. 17 illustrates a logic flow in accordance with one embodiment.

FIG. 18 illustrates a logic flow in accordance with one embodiment.

FIG. 19 illustrates a wireless communications system in accordance with one embodiment.

FIG. 20 illustrates a wireless communications system in accordance with one embodiment.

FIG. 21 illustrates a system in accordance with one embodiment.

FIG. 22 illustrates a system in accordance with one embodiment.

FIG. 23 illustrates a system in accordance with one embodiment.

FIG. 24 illustrates computer readable media in accordance with one embodiment.

### DETAILED DESCRIPTION

Aspects with respect to the generation and initialization of the sensing signal are described herein, considering cases of both a positioning reference signal (PRS)-based sensing signal or a newly defined sensing signal. In addition to the sensing signal resource and multiplexing aspects, and sensing signal generation (e.g., sequence-based signal generation and initialization), handling of interferences impacting sensing operation for a joint communication and sensing system design are described. The same or similar concepts/logic from a PRS design (or other existing communication signals) may be also applicable/expandable to sensing.

Embodiments may be implemented in various wireless communications systems, such as Third Generation Partnership Project (3GPP) systems, including long-term evolution (LTE), 5G New Radio (NR) and 6G cellular networks, for example. Various 3GPP documents define PRS, including specifications covering signal generation, mapping to orthogonal frequency division multiplexing (OFDM) resources, and configurations such as muting, for a 5G NR and 6G system, including 3GPP Technical Standards (TS), Technical Reports (TR), Change Request (CR), and/or Work Items (WI). Various embodiments discussed herein may be implemented in a wireless communications system, for example, as defined by the 3GPP TS 138.214, V17.6.0, titled “NR; Physical layer procedures for data (Release 17)”, June 2023; 3GPP TS 138.211, V17.5.0, titled “NR; Physical channels and modulation (Release 17)”, June 2023; 3GPP TS 37.355 V17.6.0 (2023-09); and other 3GPP standards developed as part of technology development for 6G and 6G standardization. It may be appreciated that the embodiments may be implemented in accordance with other 3GPP TS, TR, CR and WI, as well as other wireless standards released by other standards entities. Embodiments are not limited in this context.

The feasibility of reusing New Radio (NR) Positioning Reference Signal (PRS) for sensing purposes is established and analogies and differences between the NR PRS signal's resource attributes, as well as the desired resource structure for the sensing signal, have been identified. Further, certain expansion and enhancements of the NR PRS signal design, in order to enable and/or improve sensing functionality/performance, have been undertaken. Based on the similarities between desired properties and regularities of the sensing signal and the supported patterns and structure of the PRS signal, if a new sensing signal is defined in the next generation of cellular systems, likely it can be also used for positioning, especially, if the design accommodates backward compatibility. Examples of a cellular system may include a system defined in accordance with one or more Third Generation Partnership Project (3GPP) standards or other wireless standards. From the resource efficiency and overhead perspective, it may not be desirable to have both the positioning signal and the sensing signal being transmitted in the system, at least not at the same time, as much as possible. On the other hand, it is also logical to adapt the positioning reference signal to accommodate the sensing needs as much as possible. It is with these and other considerations in mind that the following disclosure is made.

The words/abbreviations base station (BS), cell, next generation node B (gNB), and transmission-reception point (TRP) have been interchangeably used to denote the network entity which transmits/receives radio signals. Regardless, the concepts as described herein are equally applicable to different forms of network entities. The terms sensing entity, sensing entities, sensing and communication entity, or sensing and communication entities are used herein to refer to a base station, cell, gNB, or TRP that performs sensing operations.
Transmission-Reception Point (TRP): A set of geographically co-located antennas (e.g., an antenna array with one or more antenna elements) supporting transmission point and/or reception point functionality.
Transmission Point (TP): A set of geographically co-located transmit antennas (e.g., an antenna array with one or more antenna elements) for one cell, part of one cell or one PRS-only TP.
Transmission points can include base station (e.g., eNodeB) antennas, remote radio heads, a remote antenna of a base station, an antenna of a PRS-only TP which only transmits PRS signals for PRS-based transport block size (TBS) positioning and is not associated with a cell as defined in 3GPP TS 137.355, and so forth. One cell can be formed by one or multiple transmission points. For a homogeneous deployment, each transmission point may correspond to one cell.

### Potential Sensing Frameworks/Architectures in Cellular Systems

In future cellular systems, depending on various sensing applications, use cases, and capabilities, JCAS operations can be base station (BS)-based, user equipment (UE)-based, or based on both the base station and user equipment. For example, the following cases can exist.
Case 1: The gNB (a New Radio (NR) base station) sends the sensing radio signal and receives/measures/processes its reflections from objects/environment, in time, frequency, and spatial/angular domains. If the same gNB also receives/measures/processes the reflected signal, the scenario is known herein as gNB-based monostatic sensing mode. If other gNB(s) are involved in receiving/measurement/processing, the scenario is known herein as gNB-based bi-static (multi-static) sensing mode by cooperative network nodes.
Case 2: The gNB sends the sensing radio signal and the UE receives/measures/processes its reflections (bi-static sensing mode).
Case 3: The UE sends sensing radio signal and the same or different UE(s) receives/measures its reflections (corresponding to UE-based monostatic and bi/multi-static sensing modes, respectively).

For cases 1 and 2, the sensing signal can be based on the downlink positioning reference signal (DL PRS), some extended or adapted version of the DL PRS, or some newly designed sensing signal. There is also the possibility of combining cases 1 and/or 2, also with the case where the UE receives/measures the gNB's radio signal for the positioning purposes, e.g., when the gNB's signal is based on the DL PRS signal. As can be seen from the above cases, sensing operations may require transmission/reception from multiple nodes to perform coordinated environment or neighborhood perception by multiple gNBs and/or UEs.

Further, by enabling PRS-based sensing, the JCAS system can support both base station-based monostatic sensing and user equipment-based bi-static sensing, where the base station operates as the PRS signal transmitter and the user equipment operates as the PRS signal sensing receiver, as well as user equipment-based positioning.

The disclosure herein is not limited to a particular sensing architecture or use-case and is kept general to the extent possible. In some embodiments, gNB-based sensing is the sensing scenario and architecture. Further, while the air-interface signal design can be applicable to monostatic or bi/multi-static sensing architectures, in some embodiments, the air-interface signal design is monostatic wherein the base station uses its own transmitted signals and their reflections in order to scan/monitor the environment, identify objects/targets, etc. This means that the transmitter and receiver for the sensing node would be the same network element, e.g., same base station. Similarly, this disclosure is not limited to a particular use-case family.

### Overview of Sensing Signal Frame Structure

Assume SCS denotes the Sub-Carrier Spacing, K is the slow (Doppler) Fast Fourier Transform (FFT) size, OS denotes the OFDM Symbol, and SRI is the Symbol Repetition Interval. The following SRI values and Doppler FFT sizes are proposed to support the highest possible capabilities for velocity estimation under different limitations, and to meet finer velocity resolutions, while keeping the design as simple as possible without compromising supported sensing performance.

For all carrier frequencies in a first frequency range (FR1), the following SRI and Doppler FFT sizes (K) are supported:
For SCS=15 KHz, {SRI, K}={7OS, 32}, {7OS, 64}
For SCS=30 KHz, {SRI, K}={14OS, 32}, {14OS, 64}, {7OS, 64}, {7OS, 128}
For SCS=60 KHz, {SRI, K}={28OS, 32}, {28OS, 64}, {14OS, 64}, {14OS, 128}
   These result in sensing block duration=SRI*K=16, 32 msec. For a second frequency range (FR2), the following SRI and Doppler FFT sizes (K) are supported:
For SCS=60 KHz, for all carrier frequencies in FR2, {SRI, K}={7OS, 64}, {7OS, 128}, which results in sensing block duration=SRI*K=8, 16 msec. Further, for frequency <30 GHz in FR2, {SRI, K}={14OS, 32}, {14OS, 64}, {14OS, 128} are also supported, resulting in sensing block duration of 8, 16, 32 msec. For frequency >50 GHz in FR2, {SRI, K}={7, 256} is also supported, resulting in sensing block duration of 32 msec.
For SCS=120 KHz, for all carrier frequency in FR2, {SRI, K}={14OS, 64}, {14OS, 128} are supported, resulting in sensing block duration of 8, 16 msec, and {SRI, K}={7OS, 64}, {7OS, 128} are also supported, resulting in sensing block duration of 4, 8 msec. Further, for carrier frequency >50 GHz in FR2, K=256 is also supported, resulting in sensing block duration of 32, 16 msec for SRI=14, 7OS, respectively.

The number of OFDM symbols in the SRI should provide a good a balance between the maximum detectable speed, the sensing repetition gain, the flexibility/capability to support multiplexing between sensing and communication, and the field-of-view (FoV) coverage (depending on the number of beams, and the beamwidth). Further, as can be seen from the proposed values above, the Doppler FFT sizes are generally smaller in FR1, which involves a smaller number of radio frames for sensing and less limitation and unavailability for communication. Also, the PRS configuration may be extended to allow single-symbol PRS resource, to accommodate a larger number of symbols or more PRS resources (and directions) within the SRI, for better FoV coverage, and/or better processing gain, as well as more flexibility in terms of multiplexing of communication and sensing symbols.

Further, the cyclic prefix (CP) durations are presumed to be the same as in NR communication, and are also assumed for the OFDM symbols used for sensing. In case of using a different CP (and hence symbol duration) between communication and sensing (which may be mainly motivated if there is a need to support longer sensing ranges (>100 m) with higher SCSs in FR2, where the current CPs may be short), proper alignment between sensing block durations and communication slot boundaries is obtained, in some embodiments. As also discussed herein, a communication block can be defined by the overall time interval over which no sensing symbol is taking place. The communication block's boundaries are aligned with some known time units (symbol, slot, subframe, or frame as defined in NR). Similarly, a sensing block is defined by the time interval within which at least some symbols are used for sensing with a certain pattern (e.g., the sensing block may start and end with sensing symbols, and in between, depending on the SRI, etc., some symbols are also dedicated to sensing).

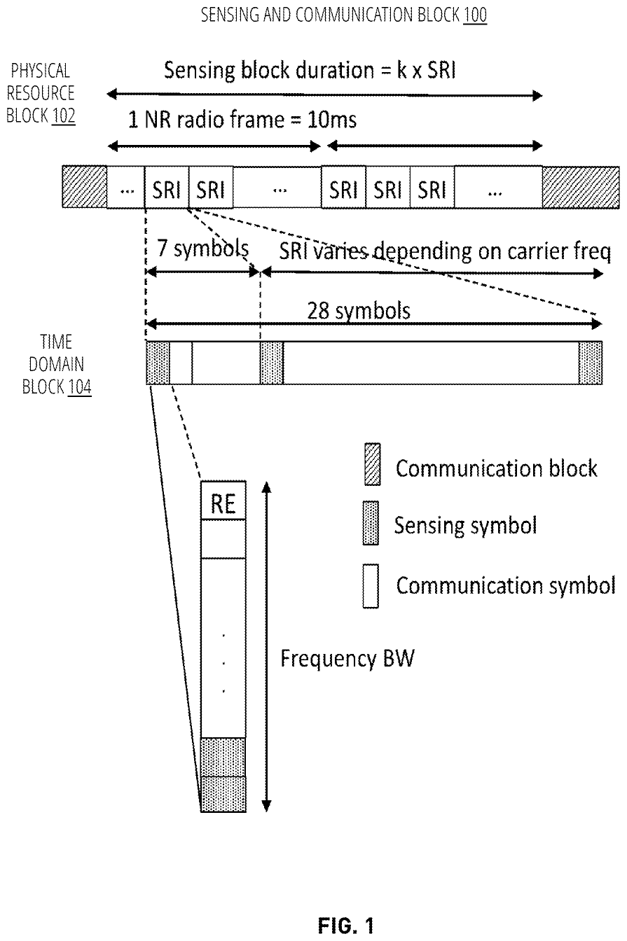

FIG. 1 is a representative drawing illustrating a sensing and communication block 100, according to some embodiments. Symbol repetition intervals (SRIs) are shown sandwiched between two communication blocks of a physical resource block 102, with the sensing block in which the SRIs reside having a sensing block duration K×SRI. In the example shown, the sensing block duration is three NR radio frames.

Below the sensing and communication block 100, a portion of the SRI is shown in more detail. In this example, the subcarrier spacing (SCS) of the SRI is 60 KHz. A time domain block 104 of the SRI portion includes sensing symbols and communication symbols. In some embodiments, the time domain block 104 has a width of 35 symbols (28+7). In the 28-symbol portion, the SRI varies depending on the carrier frequency. The seven symbol section features one sensing symbol at each end, with communication symbols in between, and the 21-symbol section 110 consist of communication symbols with a sensing symbol at the end. In some embodiments, the SRI varies depending on the carrier frequency.

A frequency domain block 106 features resource elements (REs) at a predefined frequency bandwidth 120 (according to the criteria given above). Some of the REs are sensing symbols and some of the REs are communication symbols, as shown.

The sensing block's boundary may be aligned with the communication block's boundary at some NR-based units. In some embodiments, the sensing needs at least the symbols at the SRI boundaries. Other symbols within the SRI can be used for sensing, or for time division multiplexing of the communication and sensing operation. For this example, the SRI can be 7, 14, or 28 OFDM symbols.

### Inter-Cell Interference Handling

For the base station-based monostatic sensing scenario, the inter-cell interference problem consists of the base station receiving other base stations' signals (including communication or sensing signals) as interference to its own desired echoed and received sensing signal. Within a cell, the communication and sensing signal may be time-domain multiplexed, and as such no interference is expected from communication transmission (to/from UEs) to the sensing operation.

Additional forms of interference include co-site, inter-sector interference, and self-interference between a base station's transmitter and receiver. For co-site, inter-sector interference, the problem is in many ways similar to the inter-cell interference problem, with the difference being that the interfering signal is much stronger, since it is coupled by somewhat closely spaced antenna that are co-located but arranged to transmit in different directions. Thus, for co-site, inter-sector interference, time domain isolation is often performed, in some embodiments. At least for the case when the PRS signal with potential extensions and adaptation is used to perform sensing, the PRS sequences are mapped to different (e.g., orthogonal) time resources (different PRS resources corresponding to one PRS resource set in a cell are usually time domain multiplexed), and, as such, intra-cell interference is greatly reduced. Co-site interference can also benefit from digital interference cancellation due to the close proximity and thereby tighter timing achievable between inter-sector transmitters.

For self-interference, the design of the base station's transmitter and receiver, in some embodiments, take full duplex operation into account in their design so that the strong transmitter signal does not saturate the receiver. Physical separation between co-planar transmitter and receiver antenna panels affords considerable isolation, especially at higher frequencies. In addition, RF absorbing materials can be incorporated into the antenna panel design to increase transmit and receive isolation. Within the transmitter and receiver, both analog and digital self-interference cancellation algorithms can be applied to reduce the overall self-interference.

Since co-site, inter-sector interference and self-interference can be largely addressed through timing control and careful design practice, the largest remaining source of interference is inter-cell interference. Inter-cell interference, due to the large physical separation between base stations, cannot directly take advantage of the close timing available for self-interference and intra-site interference, so digital cancellation algorithms are much less feasible. Accordingly, the main problem for sensing operation for the base station is caused by signals from other cells.

From the inter-cell interference perspective, for the case of sensing via the PRS signal, sensing signal transmissions (e.g., PRS transmissions) from different cells, mainly rely on avoiding transmission on the same resources, by means of time domain and/or frequency domain separation. Besides, pseudo-orthogonality between the generated signals provides further inter-cell interference randomization in certain situations, e.g., in case there is an overlap from any other far-away cell that was not intended, etc. For example, in the PRS's cᵢₙᵢₜ, the OFDM symbol index and slot index may provide inter-cell interference randomization in case of persistent collisions in the time domain, e.g., PRS interfering with another signal/channel. Also, the parameter,

$${n}_{ID , seq}^{PRS} ,$$

which is one of the parameters describing the DL-PRS resource, can be flexibly configured, such that the initialization for the sequences generated between different cells is different. Thus, aspects with respect to separation in time, frequency, and/or spatial domain for mitigating/avoiding/handling the interference to sensing operations are discussed in detail herein.

Sensing signal design may allow for separation/orthogonality in multiple domains. For example, the NR PRS design supports separation of the PRS signal in the time domain (at the level of PRS resource, e.g., intra-slot-level, as well as the at the level of resource set and repetitions across slots (inter-slot-level), e.g., via muting), in the frequency domain (via a comb structure and using different subcarrier offsets for different cells to transmit over the same OFDM symbol), and in the sequence domain. For sensing via the PRS signal, the same multi-domain separation can be maintained, helping with avoiding/reducing interference from sensing signals transmitted by other cells. Further, in case a new sensing signal is being adopted, similar multi-domain orthogonality is supported, in some embodiments.

Depending on the base stations' spacing and transmit powers, the base stations' self-signal echo may or may not be of lower power compared to signals from other base stations. Accordingly, this can impact the level of degradation in sensing performance caused by interference. For example, it may be the case that the direct path interference from an adjacent cell is a strong interferer compared to a reflected sensing signal in the current cell. The interference to a base station's sensing signal can be from sensing or communication signals of other base stations.

Handling Interference to Sensing Operations in One Cell, Due to Other Cells' sensing and/or Communication Signals

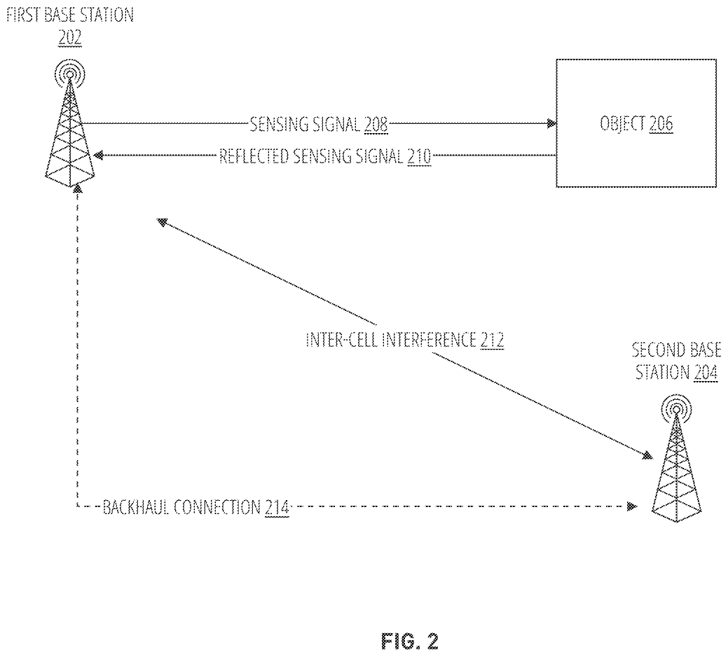

FIG. 2 is an example of inter-cell interference for sensing, according to some embodiments. A first base station 202 issues a sensing signal 208, which bounces off an object 206 as a reflected sensing signal 210. Inter-cell interference 212 from sensing or communication symbols to the sensing receiver may also occur from a second base station 204. A backhaul connection 214 is disposed between the base station 202 and the base station 204.

Monostatic sensing can have approximately double the pathloss (in dB) compared to line of sight (LOS) communications, due to the distance that the sensing signal (and its reflection) need to travel between the transmitter and the receiver. For example, pathloss for few carrier frequencies at a range of 100 m (assuming a path loss exponent of two) is shown in Table 1.

TABLE 1
Pathloss for three different carrier frequencies at a range of 100 m

| | | | | | | |
|---|---|---|---|---|---|---|
| Carrier Frequency | 4.5 | GHz | 28 | GHz | 60 | GHz |
| Range | 100 | m | 100 | m | 100 | m |
| Pathloss | 136 | dB | 153 | dB | 159 | dB |

To make up for the loss in received signal power, averaging or repetition of symbols can be used to achieve signal processing gain. The significant pathloss that sensing suffers from, compared to line-of-sight communication, is also a factor in the situation of interference. Under interference, even averaging to compensate for sensing pathloss also picks up the interference strongly. As such, at least in certain scenarios, the interference from other cells' communication signals to one cell's sensing may be more pronounced compared to the interference from other cells' communication signals to one cell's communication. Accordingly, in such scenarios, interference handling methods to mitigate the communication-to-communication interference may not be adequate to deal with the interference from the communication to sensing (depending on the base stations' distance, transmit powers, etc.). For such cases, some form of cooperative time domain multiplexing between cells may be the most effective way to resolve the interference problem, such as by using muting with coordination between cells (helpful either for interference from other cells' communication signals or other cell's sensing signal). In general, the separation of signals between signals from different base stations to address inter-cell interference can be achieved in one or multiple domains.

### Frequency Domain Orthogonality/Separation

Overview of NR DL-PRS Interference Handling/Suppression by Frequency domain Separation

DL PRS is designed to allow the user equipment to perform accurate Time of Arrival (ToA), Angle of Departure (AoD), and other measurements in the presence of interfering DL PRSs from nearby Transmission/Reception Points (TRPs). Each symbol of the DL PRS has a comb structure in frequency. In the context of 3GPP, a comb structure refers to a configuration or arrangement of subcarriers in a cellular communication system. More particularly, a comb structure refers to an arrangement of evenly spaced subcarriers used in OFDM-based cellular communication systems to maximize spectral efficiency and enhance overall system performance. Specifically, it is a method of dividing the available frequency band into a series of evenly spaced subcarriers. The comb structure is characterized by having subcarriers with equal frequency spacing, resulting in a regular and predictable pattern of subcarrier allocation. This structure is typically used in orthogonal frequency-division multiplexing (OFDM) systems, such as in Long Term Evolution (LTE) and 5G New Radio (NR). By using a comb structure, the available frequency spectrum can be efficiently utilized and shared among multiple users or services. The equal spacing between subcarriers allows for easy separation and demodulation of the transmitted signals at the receiver end, thereby improving the system's performance in terms of capacity, spectral efficiency, and interference resilience.

In one embodiment, for example, the PRS utilizes every Nth subcarrier. With a comb-N pattern, for integer N, the DL-PRS from N different TRPs or base stations can be frequency domain multiplexed (FDM) within the same frequency bandwidth and over the same slot and OFDM symbol(s), by assigning different frequency offsets for different TRPs/BSs, which implies a frequency reuse factor of N.

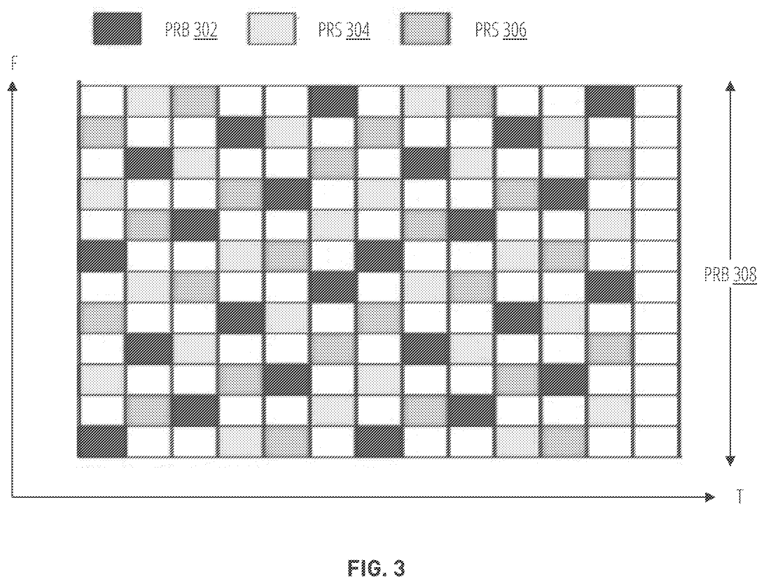

FIG. 3 illustrates an example PRS arrangement for supporting three different base stations according to some embodiments. A physical resource block (PRB) 308 is populated with PRSs 302 for a first base station, PRSs 304 for a second base station, and PRSs 306 for a third base station. The PRB 308 is arranged in the time (x-axis) and frequency (y-axis) domains. The pattern shown in FIG. 3 corresponds to a comb-6 (N=6) pattern, with three the PRS 302, PRS 304, and PRS 306 for three different base stations being multiplexed over one slot duration to avoid interference among them.

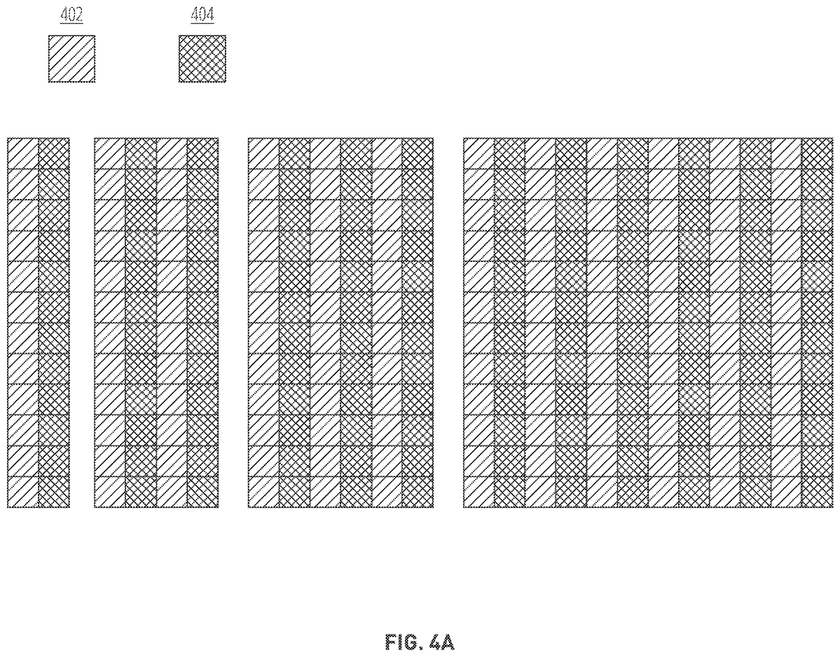

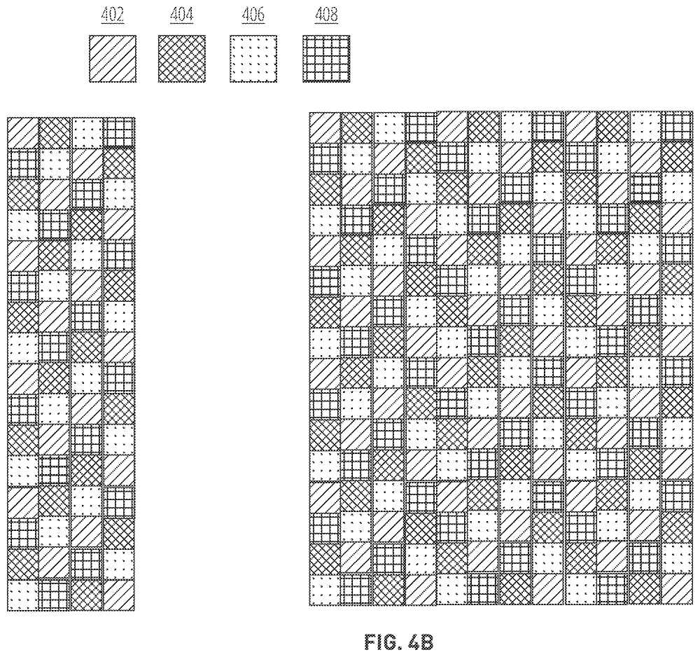

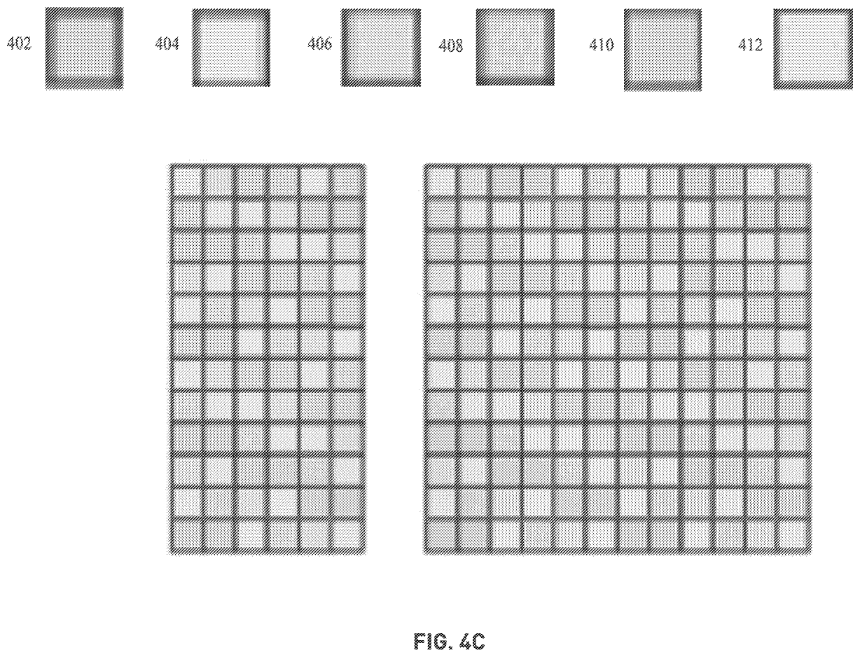

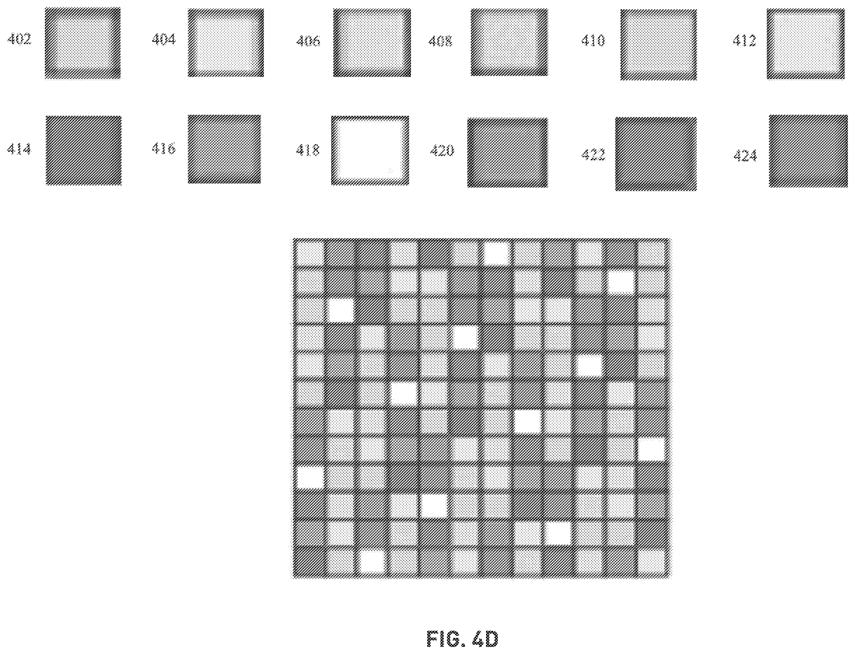

FIGS. 4A-4D are representative drawings of downlink positioning reference signal transmission patterns per PRS resource, according to some embodiments. FIG. 4A shows a PRB with PRSs for dual base stations 402 and 404 (e.g., a comb-2 structure). FIG. 4B shows a PRB with PRSs for four base stations 402, 404, 406, and 408 (e.g., a comb-4 structure), FIG. 4C shows a PRB with PRSs for six base stations 402, 404, 406, 408, 410, and 412 (e.g., a comb-6 structure), and FIG. 4D shows a PRB with PRSs for twelve base stations 402, 404, 406, 408, 410, 412, 414, 416, 418, 420, 422, and 424 (e.g., a comb-12 structure). The pattern shown in FIG. 4C, which is a comb-6 structure, is distinguishable from that of FIG. 3, which is also a comb-6 pattern, in that the pattern in FIG. 4C is a comb-6 pattern corresponding to six base stations multiplexed over one slot duration while FIG. 3 is a comb-6 pattern corresponding to three base stations multiplexed over one slot duration.

FIGS. 4A-4D illustrate that, for comb-N PRS, N symbols can be combined to cover all the subcarriers in the frequency domain. Each base station can then transmit in different sets of subcarriers to avoid interference.

The length of the PRS resource within one slot is a multiple of N symbols and position of the first symbol within a slot is flexible as long as the slot consists of at least N PRS symbols. This allows accumulation of contiguous sub-carriers across a slot which improves correlation properties for Time Of Arrival (TOA) estimation. The resource element (RE) pattern can be shifted in the frequency domain, with a frequency offset of 0 to N−1 subcarriers, which allows N orthogonal DL PRSs to utilize the same symbols. All configurable patterns cover every subcarriers in the configured bandwidth over the pattern duration (e.g., for comb-6 DL-PRS, as shown in FIG. 4C, the pattern repeats after six OFDM symbols), which provides the maximum measurement range for ToA measurement in scenarios with large delay spreads. The length of the NR DL-PRS can be flexibly configured down to two symbols which, for example, can be useful in indoor scenarios where coverage is not an issue.

There is a tight correlation between the number of allowed orthogonal signals (e.g., comb factor), and the coherent integration duration (e.g., the PRS resource time duration). Currently, for smaller coherent integration times, a lower degree of orthogonality (e.g., smaller comb factor) is supported (e.g., comb-2 PRS resource configuration). For example, a NR PRS comb-12 configuration allows for twice as many orthogonal signals as a comb-6 PRS, which is useful to mitigate interference. Since several base stations can transmit at the same time without interfering with each other, the FDM solution is also latency efficient, in some embodiments.

### Frequency Domain Inter-Cell Interference Handling for Sensing: FD Comb

Similar to PRS, base station-based sensing, either based on a PRS with potential extensions and adaptations (PRS) or based on a dedicated sensing signal, may also benefit from allocation of sensing signals from different network entities to different subcarriers over the same OFDM symbol(s). On the other hand, it is also noted that an FD-comb approach is mainly motivated for the cases where different base stations use the same or overlapping time resources, which may not always be the case, e.g., depending on key performance indicator (KPI) requirements for Doppler estimation, etc., as discussed in more detail below.

For the cases where time-domain resources for signals from different base stations overlap, frequency domain multiplexing may be achieved by using the FDM-comb structure to allocate a neighboring base station's sensing signal over different subcarriers across the same bandwidth (e.g., via a cell-specific frequency sub-carrier offset). However, the drawback of this approach is that the FD-comb structure causes discontinuous use of subcarriers, which in turn, reduces the maximum unambiguously detectable range, d_{max,unambig}, (since it increases the effective subcarrier spacing (SCS), and the largest unambiguously measurable range (for reliable radar operation and to avoid aliasing) is limited by the inverse of SCS, d_{max,unambig}≤(c₀/(2×SCS)).

In modulation symbol-based processing, the signal in the frequency domain is inherently discretized and the maximum unambiguous range corresponds to the distance that signal travels during the elementary OFDM symbol duration, which is equal to the inverse of the subcarrier spacing (SCS). Two targets, located at ranges d and d+d_{max,unambig} cannot be distinguished by the sensing receiver.

On the other hand, the range limitation imposed by the Cylic Prefix (CP) duration, in order to achieve Inter-Symbol Interference (ISI)-free range detection, is much more stringent than the maximum unambiguously measurable range and can be the limiting factor. The maximum ISI-free distance meets the following condition, d_{max,no-ISI}≤c₀T_{cp}/2, where T_{cp} denotes the cyclic prefix duration. This condition is due to the channel's multipath propagation physical limits, to avoid ISI, and preserve orthogonality between modulation symbols. The guard interval duration is related to the maximum expected multipath delay, to allow fully compensating multipath propagation effects and ensure no ISI. This guarantees no de-orthogonalization in the received matrix. Particularly, if the received signal is delayed for more than CP, the modulation symbols are aligned incorrectly and de-orthogonalization occurs, resulting in ISI. But, if the above condition is met, symbols are not shifted too far from their original position and can correctly be demodulated. d_{max,no-ISI} is the limit within which objects can be detected with high quality. Particularly, there is a graceful degradation in range detection performance if the target is beyond the CP limit. ISI reduces the peak-to-noise ratio, which degrades as moving away from the CP limit. However, d_{max,unambig} is the maximum clearly measurable range and is an absolute physical limit not to be exceeded, in some embodiments. As such, for a practical system, dimensioning of the CP duration for a given subcarrier spacing may not necessarily be to achieve ISI-free detection for the maximum desired distance, and the system tolerates non-ideal performance up to the distance n×(c₀T_{cp})/2, where the value n is properly selected (considering the environment to be sensed, transmit power, etc.) such that, objects at distance, d, where d meets the following conditions: d_{max,no-ISIS}≤c₀T_{cp}/2≤d≤n×c₀T_{cp}/2≤d_{max,unambig}=c₀/(2×SCS) can still be detectable (without aliasing), but with some potential reduction in detection performance. Based on some preliminary evaluations with simplified assumptions regarding the environments, n≤~5 may still be a reasonable choice (while n=1 results in ideal ISI-free performance).

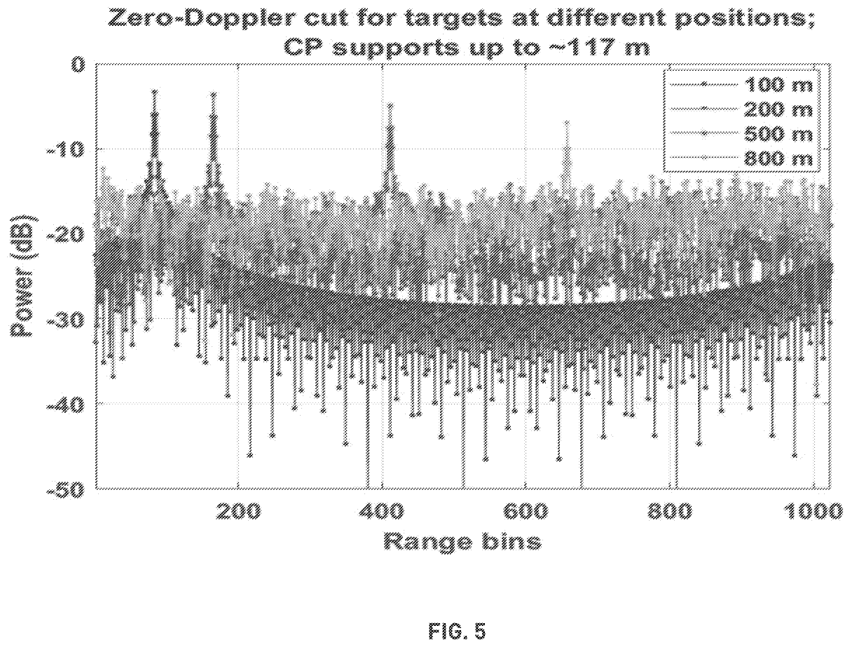

FIG. 5 shows an example of range bin estimation for different target positions beyond ISI-free range. The graph demonstrates the impact of sensing performance when a target's range is beyond the c₀T_{cp}/2, but shorter than d_{max,unambig}. A graceful degradation of range bin estimation can be seen in the absence of noise (here, zero Doppler is considered for simplicity; no noise to showcase the effects).

Table 2 shows the system parameters related to sensing range detection, where the calculations are based on existing NR CP lengths. As can be seen from FIG. 5, even if up to five times c₀T_{cp}/2 is still detectable, and as can be seen in Table 2, this distance is still much smaller (e.g., less than half) compared to an unambiguous range with a consecutive use of subcarriers. As such, reducing max unambiguously detectable range (e.g., by increasing the effective SCS and the non-consecutive use of subcarriers to realize the FD-comb structure as discussed above) may not introduce further limitations (at least not for all the cases).

TABLE 2
System parameters related to sensing range detection

| | | CP | | Max | | | | Max | | | |
|---|---|---|---|---|---|---|---|---|---|---|---|
| | | duration | NR | ISI-free | | | | unambig. | | | |
| | SCS | (TCP) | OFDM | distance | | | | distance | | 0.5*unambig | |
| FR | [kHz] | [us] | symbol | (c*Tcp/2) | | 5*c*Tcp/2 | | (c/(2*SCS)) | | range | |
| FR1 | 15 | 4.69 | 71.36 | 703.5 | m | 3517.5 | m | 10 | km | 5 | km |
| FR1 | 30 | 2.34 | 35.67 | 351 | m | 1755 | m | 5 | km | 2.5 | km |
| FR1&2 | 60 | 1.17 | 17.84 | 175.5 | m | 877.5 | m | 2.5 | km | 1.25 | km |
| FR2 | 120 | 0.59 | 8.92 | 90 | m | 450 | m | 1.25 | km | 0.625 | km |
| FR2 | 480 | 0.146 | 2.23 | 34.5 | m | 172.5 | m | 0.3125 | km | 0.156 | km |
| FR2 | 960 | 0.073 | 1.115 | 10.94 | m | 54.7 | m | 0.156 | km | 0.078 | km |

| | | Sensing | Max | | | | |
|---|---|---|---|---|---|---|---|
| | | symbol | ISI-free | | | Range | |
| | Slot | [us] | distance | | | resolution | |
| FR | [ms] | (CP >= 0.78125) | (c*Tcp/2) | | BW | (c/2*BW) | |
| FR1 | 1 | 71.36(4.69) | 703.5 | m | 100 | 1.5 | m |
| FR1 | 0.5 | 35.67(2.34) | 351 | m | 100 | 1.5 | m |
| FR1&2 | 0.25 | 17.84 (1.2) | 175.5 | m | 100&400 | 0.375 | m |
| FR2 | 0.125 | 9.11 | 117 | m | 400 | 0.375 | m |
| FR2 | 0.03125 | 2.86 (0.78125) | 117 | m | 400 | 0.375 | m |
| FR2 | 0.015625 | 1.82 (0.78125) | 117 | m | 500 | 0.3 | m |

Accordingly, in some embodiments, the design enables up to three base stations to share the same time resources by using an FD-comb structure, e.g., comb-3 (or comb-4), without affecting the range detection performance. In other embodiments, up to four base stations share the same time resources using an FD-comb structure. Further, in the case of inactive subcarriers between the FD-comb active subcarriers, the transmit signal may, in some embodiments, be power-boosted to compensate for the reduced number of active subcarriers, which effectively improves the sensing signal-to-noise ratio (SNR). This additional transmit gain also compensates for the loss in processing gain due to the reduced number of active subcarriers.

For positioning, the limitation imposed by the non-consecutive use of subcarriers over OFDM symbols, on the range detection, is addressed using a staggered structure and de-staggering and integration over multiple OFDM symbols, to effectively benefit from all subcarriers in the configured bandwidth. For sensing, using a staggered comb structure imposes a limitation on the field of view to be covered within the SRI duration (as SRI consists of a limited number of OFDM symbols, and, within the SRI, the desired field of view is scanned, in some embodiments) and flexibility to allocate sensing symbols within the SRI. Since, in practical systems, there is a mapping between the sensing beam direction and the OFDM symbols, if multiple symbols are used for scanning a single beam, a limited number of beam directions can be covered within the SRI duration since the same set of multiple symbols cannot be used to scan a different direction. Thus, the interleaved FD-comb structure can be leveraged to share the same time resources between different network entities/cells. Nevertheless, within a single cell, different directions are scanned in a time-multiplexing manner, in some embodiments. Further, the flexibility to multiplex the OFDM symbols within an SRI for sensing and communication service substantially decreases.

As such, for sensing, in some embodiments, the OFDM symbol is packed with sensing REs so as to cover the largest field of view. This achieves maximum velocity sensing to capture the entire sensing image quickly with fewer OFDM symbols than to spread out the same number of sensing REs over a long time. Furthermore, to accomplish sensing using the DL-PRS signal, in some embodiments, PRS configurations also support configuring PRS resource with a duration of a single OFDM symbol, with subcarrier usage of 1, ½, ⅓ and ¼, for the purpose of orthogonal transmission between different (neighboring) cells.

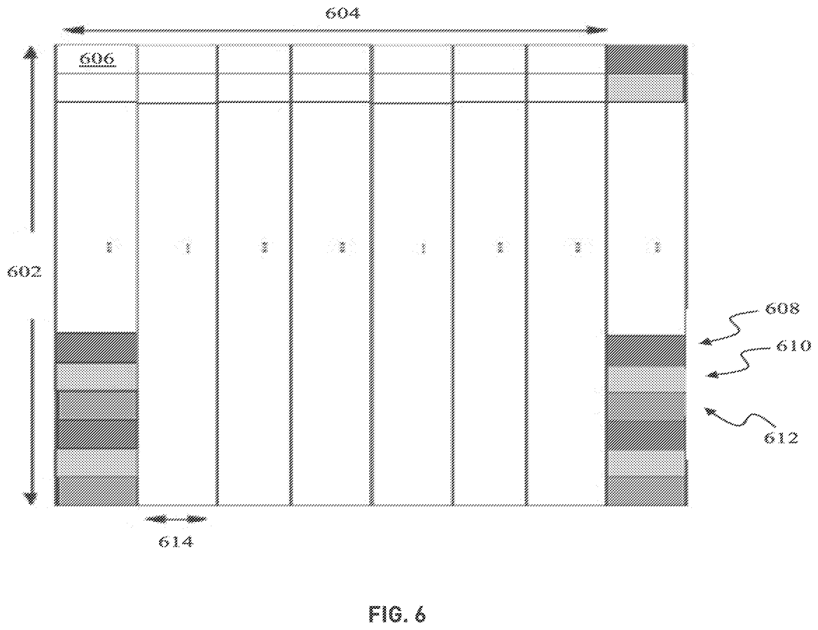

FIG. 6 is an illustration of orthogonal signal allocation using a comb-3 structure among three neighboring sensing entities (cells, transmission/reception points (TRPs), and gNBs), according to some embodiments. The frequency bandwidth 602, resource element 606, symbol repetition interval 604, and OFDM symbol 614 of the structure are shown. Resource elements for a sensing entity 608, a second sensing entity 610, and a sensing entity 612 are indicated. The sensing entities 608, 610, and 612 each represent resources for sensing transmission from different (other) sensing entities. The three sensing entities 608, 610, and 612 are using a comb-3 structure, without staggering over multiple symbols, to multiplex their signals in the frequency domain. All three sensing entities transmit their signals over the same symbols, at least with a periodicity of seven OFDM symbols.

To frequency division multiplex (FDM) the sensing resources used by different entities, in certain scenarios, a comb-N using N symbols is employed, in some embodiments, to realize a staggered comb and integrate over the N symbols, with compensation for Doppler. In terms of total resource usage, it is similar to the case of one symbol with all subcarriers being used and, depending on the available number of OFDM symbols within the SRI, this approach may be feasible in certain cases. For such cases, smaller comb-sizes, e.g., comb-2 or comb-3, for a staggered structure, may provide a reasonable tradeoff between degree of orthogonality, range detection performance, and FoV coverage.

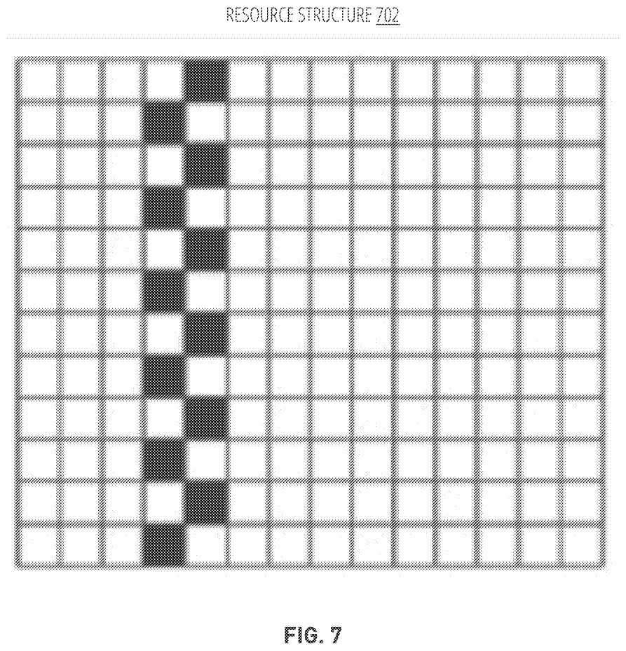

FIG. 7 depicts an example of a resource structure 702. FIG. 7 is shows a staggered comb-2 frequency domain resource structure over two consecutive OFDM symbols. For a small number of OFDM symbols within the SRI and/or in case multiple beams are used to cover the desired field of view, the structure of FIG. 7 may not be feasible. As long as the comb structure and comb degree are used over a single OFDM symbol, and the range detection performance is acceptable, the staggered comb structure using multiple OFDM symbols may not have significant benefits over this case. With time domain multiplexing (TDM) of sensing signals from different sensing entities, with each sensing entity using all consecutive subcarriers, interference from the sensing entities which use a given symbol for communication purposes, to the operation of the sensing entity which uses that symbol for sensing, can cause severe degradation in the sensing detection performance. In some embodiments, this problem is addressed by providing orthogonality over spatial/beam space and/or over the code domain. However, it is likely that a more robust approach is separation of signals from potentially direct interfering sensing entities (the base stations that one's direct signal (as opposed to reflected signals) can be easily received by another base station), in the time or frequency domains.

In some embodiments, using an FD-comb structure is mainly motivated for the transmission of different cell's sensing signals over orthogonal frequency resources. For cases where a base station may not require such resources for transmission of the sensing radio signal. For example, if a base station is not requested to perform a sensing job, or if Doppler KPI requirements are such that a sensing base station's sensing signal may not overlap in the time domain with another sensing base station, etc.. In another example, when the number of sensing base stations is smaller than the comb degree, a base station may alternatively use the interleaved frequency resources for transmission of the communication signal, e.g., under the condition that the transmit power is low enough (e.g., especially for close by cells), the receiver dynamic range can properly detect all signals, and also near-far effect does not disturb other cells' sensing operation. Still, for mitigating interference from the communication signal of one base station to the sensing of another base station, a more effective approach in some scenarios can be to use time domain multiplexing between cells, and/or to use spatial separation (e.g., with slow time coding).

The method of frequency domain multiplexing can also provide a way to support MIMO radar, wherein different transmit antennas may use the different comb resources without interfering. Since each antenna is only transmitting over a subset of subcarriers, one can boost the power in those subcarriers (e.g., if every M^{th} subcarrier (for integer M) is used, boosting by a factor of M is desired) to compensate for processing gain loss in range processing.

### Time Domain Orthogonality/Separation

In many practical scenarios, the separation/orthogonality provided in frequency, code, and/or sequence domains may adequately deal with inter-cell interference to the sensing operation. Yet the orthogonality of these methods is limited and in some cases the interference can be strong enough to cause degradation in sensing performance even with the frequency and code/sequence domain isolation/orthogonality. In some embodiments, the third type of orthogonality/separation, provided in the time-domain, has significant advantages in terms of very high orthogonality/isolation compared to the frequency or code/sequence domain.

From the perspective of interference caused by other cells' sensing signals, allocating different OFDM symbols in each slot (within the sensing block duration) for sensing by different network entities/cells, or defining sensing blocks for different cells, over disjoint slots or subframes, is beneficial. For example, it may be advantageous to align sensing time-frequency resources between cells (e.g., let these resources clash between adjacent cells) rather than letting sensing resources from one cell clash with communication signals from other cell(s). However, even if different cells transmit their sensing signal over disjoint time resources, the time resources used for sensing in one cell may still be used for communication purposes in other cells. This can impose significant interference to the sensing operation, due to the fact that, for sensing, the signal may need to travel up to double the distance compared to the communication and be of lower power compared to the received communication interference from other cells. In some embodiments, all base stations use a coordinated slot time for transmission of sensing signal (e.g., PRS) where there is no communication occurring simultaneously.

Where the frequency domain and sequence domain isolation between cells with high interference, it is not adequate to mitigate the interference problem, and time domain separation is used (e.g., for strong directly interfering signals), in some embodiments. The motivation behind such time domain separation is in synergy with the support of muting for NR DL-PRS.

### Examples of Time-Domain Separation for Interference Handling

In LTE, for inter-cell interference management, e.g., for Cell-specific Reference Signal (CRS) interference mitigation, time domain multiplexing at the subframe level is supported. Particularly, time-domain Inter-Cell Interference Coordination (eICIC) (e.g., TDM muting) is supported to enable CRS interference cancellation in pico-cells during Almost Blank Subframes (ABS). This prevents macro-eNBs from transmitting on certain subframes.

In NR (and LTE), REs carrying the Channel State Information Reference Signal (CSI-RS) can be configured to be either Zero power (ZP CSI-RS) or Non-zero power (NZP CSI-RS). For most procedures like channel measurement, beam management, beam measurement, and connected mode mobility, NZP-CSI-RS are used, and there are dedicated signaling from the base station to the user equipment to configure the reception of such signals. On the other hand, it is possible to configure a CSI-RS that occupies the configured RE but the gNB does not transmit any energy in these RE. These REs are known as zero power CSI-RS resources, which can have several use cases. ZP CSI-RS can effectively play the role of muting. Particularly, ZP-CSI-RS are set of special REs which do not contain any transmission for a particular UE, but may contain transmissions for other UE(s).

The objectives of ZP depends on which transmission hypothesis the network may want the UE to feed back, and may include providing a configuration that contains a transmission gap (“RE hole” in the Physical Downlink Shared Channel (PDSCH) transmission of the serving cell) so that the UE can perform interference measurements and provide feedback. Particularly, the UE can measure received power in this “hole”, e.g., measure a level of interference from ongoing transmissions in neighbor cells without measuring received power from its own cell provided that a “hole” is not configured also for the interfering cell. These REs puncture PDSCH so that the UE does not expect to receive any DL data within them, e.g., ZP-CSI-RS are used to configure a RE puncturing pattern for PDSCH when some REs are allocated for other purposes.

ZP-CSI-RS may be used for interference measurement. For example, NZP CSI-RS transmitted from cell A can be overlapped with a ZP CSI-RS from cell B, and when the UE is measuring the channel using NZP CSI-RS, nothing is transmitted from cell B on these REs (e.g., no interference from cell B occurs), provided that the propagation delay from these cells is comparable so the resources overlap. This improves measurement performance of the channel from cell A.

The objectives of ZP also include optional beamforming implementations where zero and non-zero power concepts can be used to distinguish between beams. Consider a beam mobility condition where a gNB uses two beams with identical physical layer settings such as bandwidth part (BWP), control resource set (CORESET), and CSI-RS resources. The gNB can configure the CSI-RS resources in an alternating mapping such that for each CSI-RS instance in the time domain, only one of two beams would have a non-zero CSI-RS. The network can schedule CSI-RS as a specific reference signal per beam to allow them to be distinguished from one another. Accordingly, the UE decided which beam has the highest CSI Reference Signal Received Power (RSRP) per beam, and, based on the CQI reports in the uplink, the gNB can decide which beam to use and whether to apply a beam switching procedure.

To handle inter-cell interference, where ZP CSI-RS can be used to protect a configured NZP CSI-RS transmission in an adjacent cell. This objective is in synergy with support of muting for mitigation of interference for sensing.

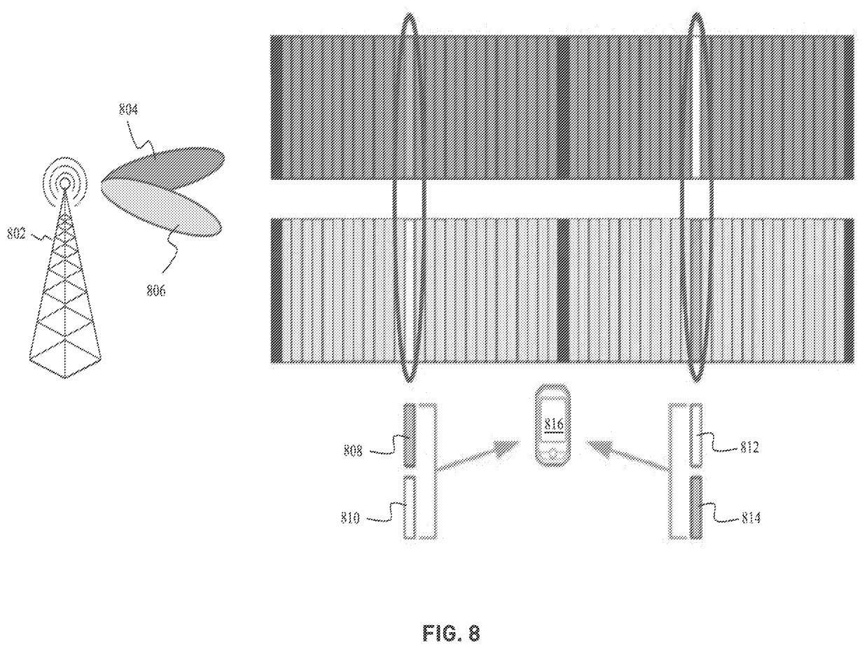

FIG. 8 is an illustration showing both zero power and non-zero power channel state information reference signals, according to some embodiments. A first BWP beam 804 and a second BWP beam 806 are issued from the base station 802. As explained above, the base station 802 can use two beams with identical physical layer settings. Thus, in FIG. 8, the BWP size of the first BWP beam 804 and the second BWP beam 806 (and CORESET) are identical. Further, the base station 802 configures the CSI-RS resources in an alternative mapping such that, for each CSI-RS instance in the time domain, only one of two beams would have a non-zero CSI-RS.

Thus, in FIG. 8, a UE 816 receives non-zero power CSI-RS on the first beam 808, zero power CSI-RS on the first beam 812, non-zero power CSI-RS on the second beam 814, and zero power CSI-RS on the second beam 810. The UE 816 is thus able is able to measure CSI-RSRP individually to decide which beam is preferred (e.g., has the higher CSI-RSRP). Because the CORESET is identical in the first beam 804 and the second beam 806, zero and non-zero power concepts can be used to distinguish between the beams. In NR, the muting of DL-PRS resources is supported, described in detail, below.

### Overview of NR DL-PRS Resource Muting for Interference Management Between Base Stations

The PRS is a downlink reference signal to be measured at the UE side and which enables finding the position of the UE. A UE does measurement per PRS resource (mapped to a particular base station's beam). By configuring the UE to measure on a certain PRS resource in a PRS resource set, a Location Management Function (LMF) learns about the TRP corresponding to the PRS resource set, and a particular beam from that TRP. DL PRS resources from different TRPs can be isolated in space (e.g., different beams), in the frequency domain (e.g., different comb offsets for different TRPs), in the time domain (e.g., different symbol offsets in a slot for different TRPs), and in the code domain (e.g., different scrambling sequences for the DL-PRS resources of different TRPs).

Use of orthogonal FD combs allows for multiplexing of multiple PRSs (e.g., from neighboring cells/TRPs) by using different, orthogonal frequency resources. But a UE needs to listen to the PRSs also from more distant TRPs (over the same time resources), causing a near-far issue. Particularly, receiving a relatively weak signal from a distant base station simultaneously with a more closely located base station transmitting may not be possible (signals from nearby cells shadow weak signals from far away cells, causing difficulty for the UE to detect far away cells/gNBs/TRPs, e.g., a loss in hearability). Regardless of whether different frequency resources are used, there may not be sufficient dynamic range in the receiver to handle both signals. Time averaging of weak signals can increase the effective dynamic range, yet there is still a fundamental limitation when strong close-in signals shadow weak far away signals, since the strong close-in signals can saturate a receiver.

Hearability of the PRS is achieved with a concept called muting, a mechanism to ensure that a near base station is silent while the UE is measuring on a distant base station. Further, if the DL-PRS resources from different TRPs collide in time at the UE receiver with the same frequency pattern (comb offset), they would only be isolated by the scrambling code, which usually does not provide sufficient isolation between near and far TRPs. Muting can turn off DL-PRS resources to reduce the interference in case of colliding DL-PRS resources.

With PRS muting, multiple cells transmit the PRS in a coordinated manner by muting relevant PRS transmission occasions to avoid interference from adjacent cells. Particularly, the design has made it possible to mute the PRS from one or more base stations at a given time according to a muting pattern, to further lower the potential interference. Combined with not transmitting data from that site at the same time instant, the net effect is a silence gap from a particular site, which allows the UE to measure on a PRS from a more distant base station. A muted PRS resource is similar to a ZP CSI-RS resource in the sense that a UE expects the gNB not to transmit on corresponding REs (e.g., muting ensures no transmission (PRS and non-PRS) over the muted PRS resources).

In summary, muting is based on base station cooperation, mainly to minimize near-far and hearability (SINR) issues, and the PRS has been specifically designed to deliver the highest possible levels of interference avoidance and suppression. PRS signals from multiple base stations can be transmitted over the same time domain resources (via a staggered-comb structure), and muting helps to avoid interference from any of these base stations to the rest.

Muting in NR is signaled, using a bit map, to indicate which configured DL-PRS resources are transmitted with zero power. There are multiple possibilities for specifying the muting pattern via a bitmap. Muting can be configured either at the occasion level, where the whole periodic DL PRS occasion (including all repetitions) can be muted, or at the repetition level, where each repetition can be individually muted within a periodic occasion.

The following three options for muting are supported:
Option 1: Muting of each DL PRS Resource Set transmission instance (assuming a periodic transmission of DL-PRS Resource Sets): Each bit in the bitmap corresponds to a configurable number of consecutive instances (in a periodic transmission of DL-PRS resource sets) of a DL-PRS Resource set. All DL-PRS Resources within a DL-PRS Resource Set instance are muted (transmitted with zero power) for a DL-PRS Resource Set instance that is indicated to be muted by the bitmap.
Option 2: Muting of DL PRS Resource Repetition Instance: Each bit in the bitmap corresponds to a single repetition index for each of the DL-PRS Resources within an instance of a DL-PRS Resource Set. Muting applies to all instances of the DL-PRS Resource Set that are part of the above DL-PRS Resources.
Option 3: Combinations of Option 1 and Option2 (if both are configured).

In some embodiments, the configuration/indication for muting is to let the UE know what to expect. Otherwise, transmission or non-transmission of the PRS or other communication signals is based on coordination between gNBs, which do not need over-the-air indication.

While the DL-PRS pattern is configured by each gNB, the configuration is likely coordinated across multiple transmission points. For example, if a UE is measuring multiple TRPs, it is not desired that the PRSs from those TRPs be sparsely spread apart in time, since the time correlation performed at the UE receiver for position estimation (also considering the UE's mobility) needs to make sense. As such, a reasonable configuration tries to have the PRS instances from different TRPs targeting a particular UE, transmitted close enough to each other. In other words, the nature of the position estimation task across TRPs leads to PRSs from different TRPs to be transmitted relatively concentrated in the time domain. If the TRPs are packed relatively

close enough in time, the positioning estimation upon fusing all information has a higher accuracy, since there is less room left for variations in the channel (e.g., due to Doppler and other changes in the environment which appear when the instances are spread apart in time). From this perspective, there are some time domain resources over which the PRSs from different bases stations are expected with higher likelihood, and muting allows to properly handle the near-far affect from signals between the nearby TRP compared to the far away TRP.

In some embodiments, as part of the parameters describing the DL-PRS resource set, the following are considerations for the muting mechanism:
A DL-PRS Resource Repetition Factor defines how many times each DL PRS resource is repeated for a single instance of the DL-PRS Resource Set. Values of {1, 2, 4, 6, 8, 16, 32} are supported. All DL-PRS resources within one resource set have the same Resource Repetition Factor.
A DL-PRS Resource Time Gap defines the offset in number of slots between two repeated instances of a DL-PRS Resource with the same DL-PRS Resource ID within a single instance of the DL-PRS Resource Set. Values of {1, 2, 4, 8, 16, 32} are supported.
A DL-PRS Muting Pattern defines a bit map of the time locations where the DL-PRS resource is transmitted or not for a DL-PRS Resource Set. The bit map size can be {2, 4, 8, 16, 32} bits long.
A DL-PRS Muting-Bit Repetition Factor, which defines the number of consecutive instances of a DL-PRS Resource Set corresponding to single bit of the DL-PRS Muting Pattern for Option 1 muting.

In some embodiments, all PRS configurations including the muting-related configurations, are based on the Radio Resource Control (RRC) configuration. The UE assumes that the following parameters for each DL PRS resource(s) are configured via higher layer parameters nr-DL-PRS-ResourceSet-r16:
DL-PRS-MutingPatternList-r16: defines the time locations where the DL PRS resource is expected to not be transmitted for a DL PRS resource set.
DL-PRS-MutingBitRepetitionFactor16: If mutingOption1 is configured, each bit in the bitmap of mutingOption1 corresponds to a configurable number (provided by this parameter which can have the values {1, 2, 4, 8}) of consecutive instances of a DL PRS resource set where all the DL PRS resources within the set are muted for the instance that is indicated to be muted. The length of the bitmap can be {2, 4, 6, 8, 16, 32} bits. If mutingOption2 is configured, each bit in the bitmap of mutingOption2 corresponds to a single repetition index for each of the DL PRS resources within each instance of a nr-DL-PRS-ResourceSet-r16 and the length of the bitmap is equal to the values of DL-PRS-ResourceRepetitionFactor-r16. Both mutingOption1 and mutingOption2 may be configured at the same time in which case the logical AND operation is applied to the bit maps.

Over the slots with the PRS, there can be time resources for transmission of other communication signals. Particularly, other signals/channels can be time division multiplexed at least to/from the other UEs within a slot with the PRS. Currently, other than the TDD configuration information exchange, there are no other inter-gNB coordination solutions specified. Coordination of this nature is typically left up to the network implementation.

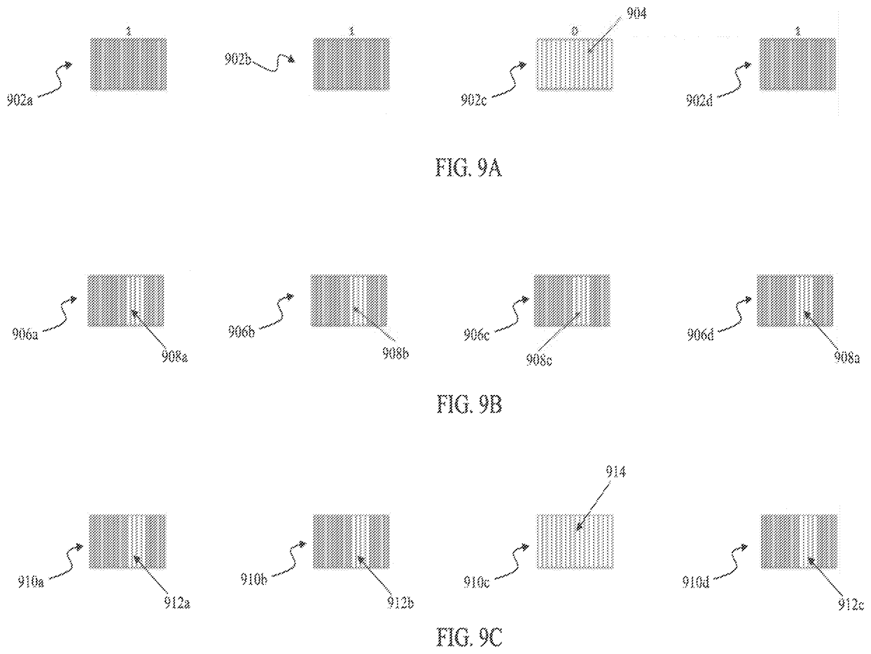

FIGS. 9A-9C are illustrations of the DL PRS muting options, according to some embodiments. FIG. 9A illustrates Option 1 muting, FIG. 9B illustrates Option 2 muting, and FIG. 9C illustrates Option 3 muting.

In FIG. 9A, a DL PRS Resource Set 902 is shown at four different instances (902a, 902b, 902c, and 902d), each instance representing periodic transmission of the DL PRS Resource Set 902. As indicated by arrow 904, all DL PRS resources are muted within the DL PRS resource Set instance 902c. A bitmap representing the DS PRS Resource Set 902 would thus read 1101, thus indicating that the third instance of the DL PRS Resource Set is muted. FIG. 9A thus illustrates muting Option 1.

In FIG. 9B, a DL PRS Resource Set 906 is shown at four different instances (906a, 906b, 906c, and 906d), each instance representing periodic transmission of the DL PRS resource set 906. As indicated by arrow 908a, four repetition indexes for the DL PRS Resource Set instance 906a are muted. Similarly, as indicated by arrows 908b, 908c, and 908d, the same four repetition indexes for the DL PRS Resource Sets instances 906b, 906c, and 906d are muted. Thus, as shown in FIG. 9B, muting applies to all instances of the DL PRS Resource Set 906. Further, each bit in the bitmap corresponds to a single repetition index for each of the DL-PRS Resources within an instance of the DL PRS Resource Set. FIG. 9B thus illustrates muting Option 2.

In FIG. 9C, a DL PRS Resource Set 910 is shown at four different instances (910a, 910b, 910c, and 910d), each instance representing periodic transmission of the DL PRS resource set 910. As indicated by arrows 912a, 912b, and 912c, four indexes for the DL PRS Resource Set instances 910a, 910b, and 910d are muted. In contrast, as indicated by arrow 914, the entire DL PRS resource of DL PRS Set instance 910c is muted. FIG. 9C thus illustrates muting Option 3, which is a combination of Options 1 and 2.

### Time-Domain Inter-Cell Interference Handling for Sensing: Muting

With cooperation between base stations, especially within the neighboring base stations, some form of TDM or muting can be also supported for sensing (besides other possible forms of separation or orthogonality, e.g., in frequency, sequence, spatial, and/or code domains). For sensing based on the PRS signal with potential adaptations, the muting is naturally inherited from the PRS design, while some adaptations

with respect to the muting operation and configuration may be needed for sensing. In some embodiments, the PRS muting specifies the mechanism to mute the PRS signal over certain time resources, while for sensing, it is also desired to enable a
mechanism to mute the communication signals over certain time resources as well.
Particularly, given that sensing performance at least in certain
situations may be more prone to the interference compared to positioning, the need for cooperative time domain separation/muting amongst base stations may be more pronounced for sensing.

In some embodiments, TDM support for signals from different base stations is realized by muting of another cell's sensing and/or communication signal, at least in the directions/FoV a given sensing base station needs to sense. The direction can vary if the base station is performing sensing based on its own transmitted radio signal (monostatic) or based on other base station(s)′ transmitted signal(s) (bi/multi-static. In some embodiments, the muting would be for a duration of one or multiple symbols, one or multiple SRIs, a sensing block duration, one or multiple slots, subframes, or frames.

For sensing based on the PRS signal, if the signals are concentrated in certain time domain resources, such a TDM scheme may be achieved by muting of the PRS signals and also ensuring no data transmission from those sites (similar to the case of PRS), with the likelihood that there would be no need for extra handling of other communication signals.

For sensing based on the PRS signal, at least for use cases motivating SRI and frame durations as discussed herein, a repetition gap of one or two (e.g., occurrence in every slot or every other slot), and a repetition factor of up to 256 can be used, in some embodiments. For PRS-based sensing, at least for such use cases, it is then more likely that focusing on option 2 muting (FIG. 9B) is more reasonable. As such, according to the placements of the base stations, the sensing architecture, and the corresponding desired FoVs, and/or base stations communication directions over overlapping time resources (e.g., for non-sensing base stations or for the ones with different time periodicities of sensing, etc.), certain PRS resources (corresponding to certain beam directions) can be muted. In some embodiments, the base station whose PRS is being muted, through proper coordination, would also mute its communication signal over the same time resources or over the same slot(s).

In some embodiments, Option 2 muting is further extended such that each PRS resource repetition in a PRS resource set instance can be individually muted or transmitted. Currently, in Option 2 muting, all PRS resources within one repetition in a PRS resource set instance are either muted or transmitted (FIG. 9B). In some embodiments, for a multi-symbol PRS resource, each symbol within the resource or each intra-resource level repetition of the PRS (if any), can be muted individually. Accordingly, when some occurrences of some beam(s) in certain SRIs within the total sensing block (which in case of reusing the PRS design for sensing, is equivalent to the resource set including all the repetitions within the set) are muted, in some embodiments, the corresponding sensing receiver processing takes the missing occurrence of the beam into account, e.g., in Doppler processing of the corresponding direction, etc.

In some embodiments, to facilitate the above extensions to muting configurations, muting parameters are defined as part of the PRS resource configuration (instead of the PRS resource set configuration). In some embodiments, a PRS resource configuration parameter (e.g., called dl-PRS-MutingPatternForResource) defines the symbol locations where part of the DL PRS resource is expected to not be transmitted.

In other embodiments, corresponding to each bit in the bitmap of DL-PRS Muting Pattern (dl-PRS-MutingPatternList-r16), another parameter is defined for each PRS resource within the set, to indicate whether the particular repetition of that PRS resource is transmitted or not. Alternatively, the size of the above bit map (which can be {2, 4, 8, 16, 32} bits long) can be expanded by multiplying by the number of resources within a set, and the bitmap indicates transmission of each resource for a given repetition index, accordingly.

In some embodiments, to more flexibly and dynamically handle the interference, some or all muting-related configuration are indicated or overrode via DL control channel (via downlink control information (DCI)). For example, DCI indication may trigger and/or stop muting at the symbol, the PRS resource, and/or the PRS resource set level.

While a gNB can avoid transmission and let the UE know that it would not transmit any signal on certain resources in different ways, in some embodiments, muting is realized through configuration of the sensing measurement gaps in the interfering cell(s). During the sensing measurement gaps, no transmission from the (interfering) base station (and potentially also from a subset of UEs served by that base station) is scheduled, in directions affecting the sensing cells' FoVs scanning. To increase efficiency, these sensing measurement gaps may overlap with existing measurement gaps supported in NR (intended for certain UE measurements, depending on UE capability), whenever possible.

Currently, 5G NR network configures a UE with measurement gaps via RRC signaling. The network configures these gaps such that they do not coincide with UE transmissions or receptions. It is possible to start with a few gaps and later reconfigure the UE with more gaps to gather neighbor cell measurements, for instance, if a handover looks likely. Measurement gaps are periodic. A UE may be configured with multiple measurement gaps. The UE RRC informs Layer 1 of these gaps. Layer 1 obeys these gaps for making measurements. Collected measurements are reported to the network either at Layer 1 or RRC.

The current NR UE measurement gap lengths of 1.5, 3, 3.5, 4, 5.5, and 6 msec, with measurement gap repetition periodicities of 20, 40, 80, and 160 msec, are supported, in some embodiments. A measurement gap pattern is also characterized by gap lengths and repetition periodicities. There are 24 gap pattern configurations defined to accommodate different system needs. Similar to the existing NR UE measurement gaps, sensing measurement gaps can be defined with length, periodicity, and pattern, potentially with finer granularities, according to the SRI duration and sensing block duration of the sensing cell(s).

In some embodiments, the sensing measurement gap configuration also includes spatial domain-related information beside the time-domain-related indication (e.g., length, repetition pattern), to increase the efficiency in resource usage.

Accordingly, transmissions (from the base station and potentially UEs) affecting the indicated spatial domain may be avoided according to the time-domain configuration.

For DL-PRS, as described above, multiple base stations can use the same time resources using a staggered comb structure to transmit their PRS resources. Further, concentration in the time domain may be also useful to improve the ranging estimation performance, which may also benefit the muting effectiveness. For sensing (at least for monostatic BS-based sensing or for bi/multi-static BS-based cases where coherent combining of information (sensing measurement) collected from different sensing nodes may not be expected), there may not be much concentration in terms of the time resources over which the sensing signal should be transmitted. As such, from the perspective of the sensing estimation task, the time domain occurrence of the sensing signal from different base stations may have more freedom to be more randomized compared to the occurrence of the PRS signal.

One the other hand, the PRS was not originally designed to enable Doppler estimation and only intends to enable range estimation. As such, the time domain repetitive pattern supported for PRS intends to provide integration/combining gain. However, sensing requires a certain regularity (repetitiveness) of the radio signal in the time domain, both to enable Doppler processing as well as the integration gain, and the parameters to define the repetition are mainly determined by Doppler estimation key performance indicator (KPI) requirements. Depending on the use-case requirements for Doppler estimation, it may or may not be possible to concentrate sensing signals from different sensing nodes in the time domain.

Particularly, the time domain occurrence of a sensing signal may not be fixed and depends on the underlying use case's speed requirements and other factors, such as SCS, carrier frequency, etc. Accordingly, even the FD-comb approach to multiplex sensing resources of different cells in the frequency domain is also mainly motivated for the cases where different base stations use the same or overlapping time resources, which may not be always the case. Still, since the sensing block duration can be multiple times (e.g., 32, 64, 128, 256) of the slot duration, it is likely that sensing blocks from different base stations overlap over multiple slots, even though the locations of sensing OFDM symbols within the slots may be different across different base stations (if needed to address different Doppler KPIs).

From the perspective of interference handling and effectiveness of muting, it is beneficial if sensing transmissions from different sensing entities are not far away in the time domain, and muting of certain cells over certain time resources can avoid interference from their sensing or communication signals to the desired cell(s)'s sensing. The fact that the interference from line-of-sight (LOS) communication to sensing can be very severe may also further motivate localizing/concentrating time resources/regions used for sensing by different cell, as much as possible.

In some embodiments, the muting of interfering cells may apply to certain slots (e.g., the ones corresponding/aligning to the desired sensing entity's SRI or corresponding sensing symbols within its sensing block), and may concern sensing transmission and/or data transmission of the interfering cell(s) over those slots. Effectively, some form of time domain multiplexing between cells or between sections of cells (e.g., corresponding to directions/FoVs which can cause direct interference) may be supported for mitigating interference from the communication and/or sensing signal of one sensing entity to the sensing of another sensing entity. Depending on the placements of the sensing entities and the desired FoVs to be sensed, there may be no need to allocate mutually exclusive time or frequency resources for every transmission. In some embodiments, muting is at the level of a half slot or one or multiple OFDM symbol(s) and target sensing and/or communication transmission over such time resources.

The positioning reference signal transmitted in a PRS resource is punctured into the data transmission for the slots wherein there are PRS resource(s), and there can be multiplexing of data and PRS at the RE/subcarrier level and also at the symbol level. Puncturing, as opposed to rate-matching the PDSCH around the PRS, is used, as devices not supporting positioning, and hence not being aware of the PRS resource configuration, cannot perform rate matching around PRS resources. If PRS-to-PDSCH interference is an issue, the gNB implementation can always schedule to avoid collisions between the PRS and the PDSCH.

In practice, there is a dedicated DL PRS resource grid, in some embodiments, in the sense that even though it is not mandated by the specification, for good performance, no other DL signal transmission is expected on the PRS resources. Similar considerations may also apply to the sensing signal (which, for the case of sensing based on the PRS with potential adaptations, can be naturally inherited). Further, there is no case of transmitting a PDSCH and a PRS in the same slot to a single UE. As such, to accommodate PRS, the puncturing of any PDSCH would be for a PDSCH for some other UE.

Currently, multiple UEs within one cell or from multiple cells may receive the same PRS signal (same content, over the same time/frequency resources, etc.). A target UE which performs DL positioning based on the configuration may listen to multiple PRS transmissions from different base stations. As such, from the base station's perspective, there can be multiple UEs at the same time across different cells listening to its PRS. In that sense, PRS is a multi-cast signal with configuration for indicating the UEs to detect and is not specifically dedicated to particular UE(s).

Spatial domain orthogonality/separation

Providing spatial orthogonality between sensing signals in different cells can be dependent on several factors, including cells/sectors planning, desired sensing FoVs, the placement, shapes, and material of objects in the environment, etc.

In general, beamforming for sensing signal transmission can be coordinated between cells to minimize inter-cell interference of sensing signals. This can be in addition to (combined with) other tools, such as using different sequences in sensing signal generation for different cells to mitigate/reduce potential intercell sensing interference, as described further below.

In handling intercell interference of sensing signals, depending on the network topology, cell planning, and desired field of views to be scanned for sensing, the direct sensing signal from adjacent cells may or may not be a strong interferer compared to reflected signal from a target in a current cell. In the following, it is shown that by smart planning of beam directions from different nodes, the network will not necessarily need to assign mutually exclusive (time/frequency) resources everywhere in the neighboring (potentially interfering) cells. In certain cases, enough level of spatial separation (potentially combined with code domain separation) can be provided which enables reuse of resources.

In one embodiment, in order to provide spatial separation between signals from different cells/sectors, the impact area of signal reflections from targets in the FoVs of the sensing transmit beam(s) are mainly separated between the base stations.

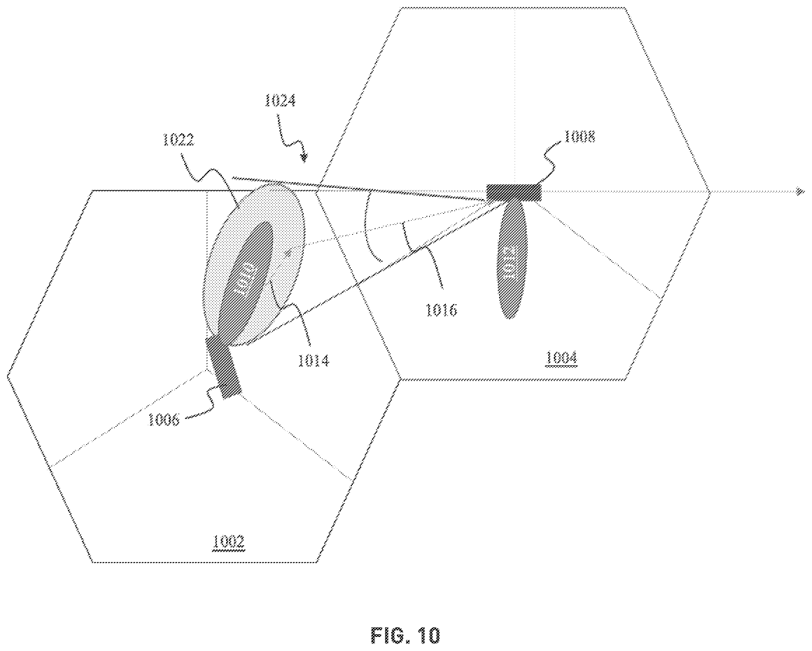

FIG. 10 is a representative illustration of interference FoV of a beam from a first base station for a second base station, according to some embodiments. A first sector 1002 having a base station 1006 and a second sector 1004 having a base station 1008 are shown. A beam 1010 is issued by the base station 1006 and a beam 1012 is issued by the base station 1008.

As illustrated in FIG. 10, one may assume that each cell has three sectors. Consider the beam 1010 of the first sector 1002 (e.g., the massive multiple input multiple output (MIMO) antennas in the cell, are pointing in the shown direction, to cover the first sector 1002). To provide spatial separation for a sensing operation in different cells, this embodiment first identifies how the sensing beam 1010 (created by the antennas), may interfere with other cells' operation.

In some embodiments, an interference field of view can be defined for each of the other cells' sector base stations (e.g., for the base station 1008 of the second sector 1004), corresponding to each sensing transmit beam in a given cell's sector (e.g., corresponding to beam 1010 from the first sector 1002 of base station 1006). To illustrate the concept of interference FoV, consider the area 1022 surrounding beam 1010, which, in some embodiments, is the area for which a target can create a reflection that can cause interference to the base station 1008 in the second sector 1004. The direct path from the beam 1010 will be limited to the FoV of this beam, which consists of a cone-shape area 1024 around beam 1010, and will not interfere with beam 1012 of the second sector 1004.

On the other hand, reflections of the transmitted sensing beam 1010, throughout the area where the signal from beam 1010 is strong enough (e.g., the area 1022 surrounding beam 1010) can cause (strong enough) interference in the direction of the second sector 1004 (e.g., as indicated by the arrows 1014 and 1016 within the cone 1024). While the shape of the beam 1010 and the beam 1012 shows the power profile, e.g., the direction in which the main transmit power emits, a larger FoV area needs to be considered for interference management. As such, any reflection which falls within the interference FoV (shown by the cone 1024) reaches the base station 1008 antenna arrays and can cause sensing signal interference within that angle range. The base station 1008 then needs to create its sensing beam (over the same time/frequency resources), outside the interference FoV from the beam 1010. Further, the FoV of the beam 1012, as well as the interference FoV from the beam 1012 to the base station 1006, should also be exclusive from the interference FoV from the beam 1010 (and the FoV of the beam 1010), to avoid mutual interference. For sensing detection and angular processing based on the transmission of each beam, only the corresponding FoV (angle range) of the beam is considered, in some embodiments, which is already separated from the interference FoV from the other beam(s).

In some embodiments, the interference FOV area, Pe, is calculated assuming a maximum radar cross section (RCS) for a target (e.g., which may be falling at the far-end within a beam's transmit FoV) and applying the radar equation based on the distance to the transmitting and receiving base station:

$${P}_{e} = \frac{{P}_{s} {G}_{1} {G}_{2} {λ}^{2} σ}{{( 4 π )}^{3} {r}_{1}^{2} {r}_{2}^{2}} ,$$

where:
Pₛ is the transmit power
Distances 1014 (r₁) and 1016 (r₂), as shown in FIG. 10
G₁, and G₂ are base station 1006 and base station 1008 antenna gains
λ is the signal wavelength
σ is the radar cross section

Normally, the network may not need to perform such calculation dynamically and may reuse the results over the operation interval. In some embodiments, for the purpose of the interference FoV calculation, the network keeps moving the assumed target around the FoV of the particular beam and measures the received reflected energy at the antenna array which may be the potential receiver of the interference. Depending on where the object is located, a different amount of energy would be reflected towards the array and can be measured.

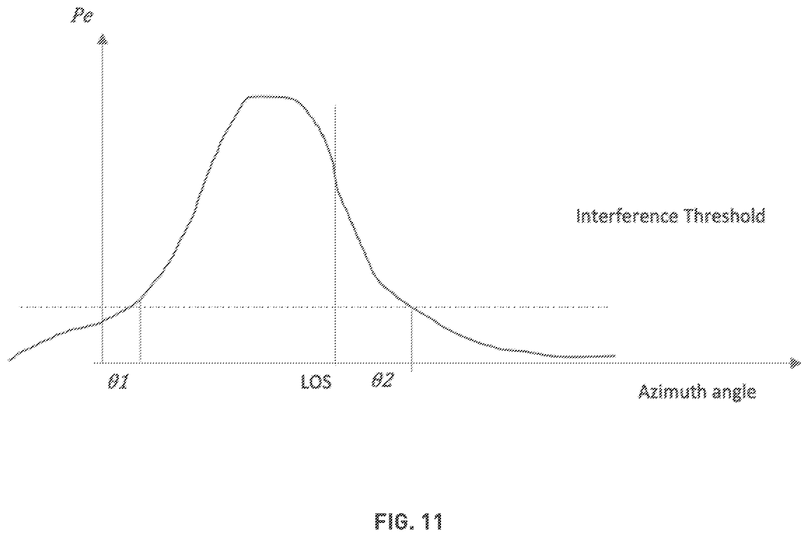

FIG. 11 is a graph illustrating how the base station 1008 (FIG. 10) receives interference power from the beam 1010 of the base station 1006 versus azimuth arriving angle. FIG. 11 shows an example of how Pe may appear as a function of the azimuth (arriving) angle at the base station 1008. For a given arriving angle, a certain target's location within the beam's FoV (e.g., which may be the closest point to the receive antenna) contributes to the maximum received interference power. On the other hand, the line of sight (LOS) path may not necessarily cause the strongest interference level.

In some embodiments, the network operator can set a (potentially non-zero) threshold on tolerable interference considering all the factors, such as the level of interference mitigation provided by using different codes for sensing signal in the two base stations, etc., to determine the interference FoV. In the above example, the interference FoV is given by θ₁ to θ₂ Azimuth angle range.

When calculating the threshold, the code-domain separation can cause a noise floor and is further randomized, in some embodiments. If the threshold is set very low, (time/frequency) resources can be reused with sufficient spatial separation without even resorting to code domain separation. On the other hand, since it can be easily realized without much added complexity, overhead, or power consumption, code domain separation can be combined with spatial separation to increase the efficiency.

In some embodiments, interference FoV (for each beam direction) can be calculated offline based on network topology information, the geometry, the cell and sectors mapping, and the orientation of antenna panels of base station(s) in the network.

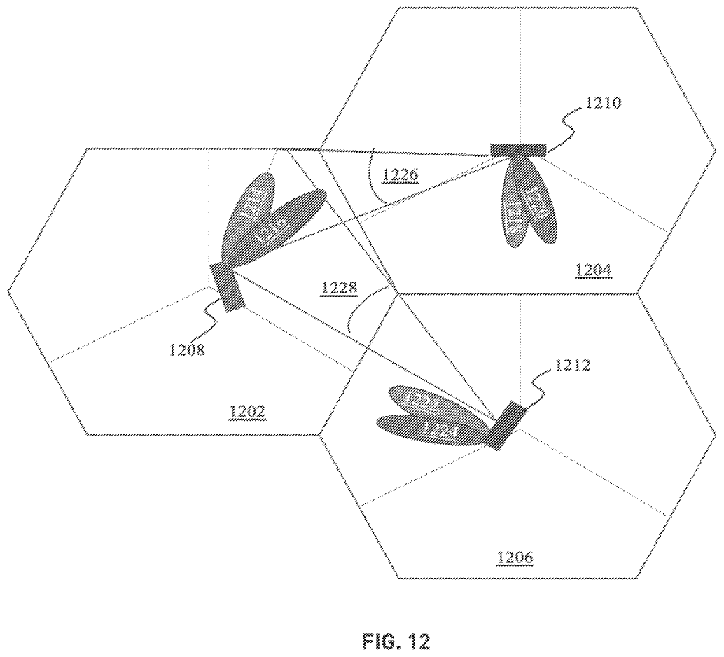

FIG. 12 is an illustration of spatial multiplexing of sensing signals using an interference FoV idea, according to some embodiments. In some embodiments, using the interference FoV idea developed above, spatial multiplexing of sensing signals is realized as follows. Consider beam 1214 in sector 1202. This beam 1214 creates an interference FoV indicated by the cone 1226 for the base station 1210 of the sector 1204, and interference FoV indicated by the cone 1228 for the base station 1212 of sector 1206. Hence the sector 1204 and the sector 1206 each can use the same time frequency resources as the sector 1202 to create beams outside these interference FoVs (e.g., beam 1218 and beam 1222, respectively). It should also be ensured that the FoVs of the beams 1218 and 1222 of the sector 1204 and the FoVs of the beams 1222 and 1224 of the sector 1206 do not interfere with each other. More beams can be added following this method.

In some embodiments, the geometry of the beams' FoV as well as the reflected path of signals from targets in the FoV are considered when determining a given beam's interference FoV on another base station.

After the cells transmit the beams 1214, 1218, and 1222 shown in FIG. 12, the cells can move to the blue beams 1216, 1220, and 1224, respectively, and the process can continue until all three sectors are swept without interfering with each other, due to the effective spatial multiplexing technique disclosed above (using the same time-frequency resources). This method provides an additional dimension to multiplex sensing signals.

In certain scenarios and network topologies, there might be geometric impossibility to avoid interference. For example, despite attempting to dimension the transmit beams based on the corresponding interference FoVs, it may be the case that the transmit FoVs and/or interference FoVs end up pointing in the same or overlapping direction(s). In such cases, separation in time and/or frequency may be unavoidable.

Further, the spatial domain separation techniques can be dependent on the base station's implementation, as well as the operation radio frequency. As such, spatial domain techniques and tools are expected to be supported in addition to dimensioning in other domains (e.g., time, frequency, and code domain).

For DL-PRS, based on the network implementation, it is possible to arrange antenna patterns so as to transmit beams with spatial orthogonality over the same time/frequency resources. However, the antenna pattern often have some overlap and side-lobes so that the degree of isolation may not be as high as other isolation methods, yet spatial isolation still adds an additional valued component toward reducing inter-cell interference. For sensing, especially in higher carrier frequencies, since the sensing is performed in a directional way, the coordination of the beams for transmission of the sensing radio signal over time resources may be helpful in reducing the level of interference.

In some embodiments, a similar approach as using ZP-CSI-RS is used for sensing beamforming implementations where the zero and non-zero power concept is used such that one beam at a time is powered and the others are empty. For example, a gNB can use multiple beams with the same physical layer settings and configure time and spatial resources in an alternating mapping such that for each sensing instance in the time domain, only one of those beams would have a non-zero power, and can coordinate the beam transmissions accordingly. Effectively, this approach can also achieve muting, e.g., at the sub-slot or symbol level.

### Code and Sequence Domain Orthogonality/Separation

Using pseudo-orthogonal sequences (with low cross-correlation) for the sensing signals transmitted by different sensing entities that may potentially be mapped even over overlapping time/frequency resources provides another layer of interference reduction and randomization, and helps with better detection performance.

Pseudo-Random (PN) sequences and their variations have been used in many ways in the current cellular systems, including the generation of reference signals, and the scrambling of data of a specific channel. In a similar spirit, in some embodiments, while sequences used for sensing signals from different entities are pseudo-orthogonal, the sensing signal sequences and the scrambling sequences used for scrambling of different communication channels, in other cells, are also pseudo-orthogonal. This becomes more important, especially in the case that the resources used for sensing signal transmission in one cell may overlap with the resources used for communication transmission in other cells.

It is also possible to code the sensing signals, e.g., within each SRI. Consider the case where the sensing (neighboring) base stations transmit sensing signals over the same OFDM symbol(s) at least over one or more SRIs within their sensing block durations (multiple base stations may or may not intend to support the same maximum Doppler KPI requirements, and may have different SRI durations, different positioning of sensing symbols within the SRI, etc.).

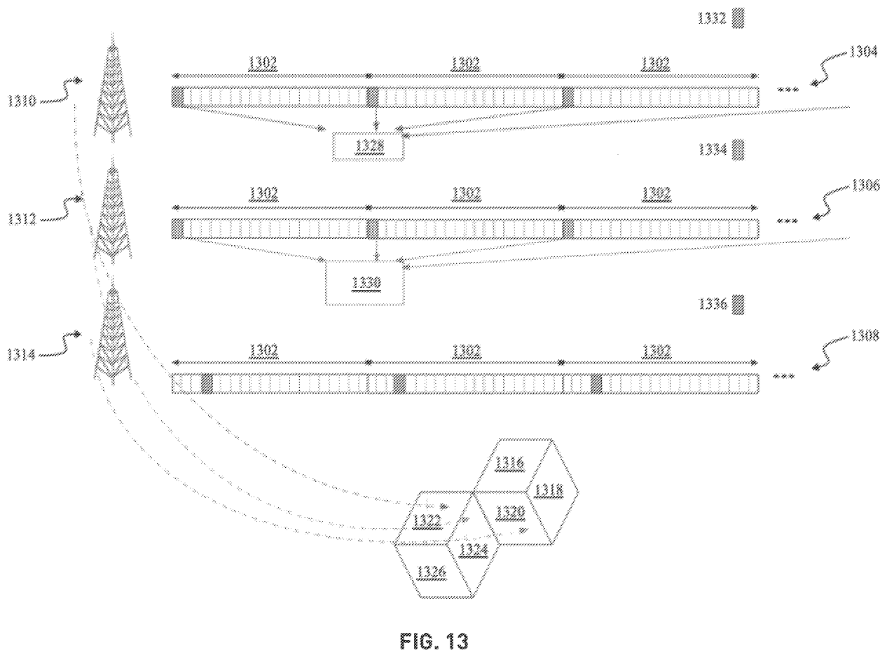

FIG. 13 is an example illustration of code domain multiplexing to mitigate inter-cell interference, according to some embodiments. A physical resource block 1304 for base station 1310, a second physical resource block 1306 for base station 1312, and a third physical resource block 1308 for base station 1314 are shown. Each physical resourced block has SRIs 1302 as shown. Further, sensing symbols 1332 are found in physical resource block 1304, sensing symbols 1334 are found in physical resource block 1306, and sensing symbols 1336 are found in physical resource block 1308. The sensing symbols 1332 in the physical resource block 1304 are at the beginning of each SRI 1302. Similarly, the sensing symbols 1334 in the physical resource block 1306 are at the beginning of each SRI 1302. In contrast, the sensing symbols 1336 in the physical resource block 1308 are not at the beginning of each SRI 1302.

FIG. 13 thus shows an example in which neighboring sensing base stations 1310 and 1312 transmit sensing signals 1332 and 1334, respectively, over the same OFDM symbol(s) at least over one or more SRIs 1302 within their sensing block durations. In such a case, there is further isolation provided by the coding between the sensing and communication signals of different cells, and only sensing signals may interfere with one other, in some embodiments. In one embodiment, in terms of handling the interference between signals from different base stations, code domain separation of sensing signals is supported. This approach may be more straightforward to mitigate interference between sensing signals, since for the interference from communication signals to sensing, there may be less control over the communication signal content, e.g., it can be random data. In some embodiments, with proper accommodations, it is also possible to apply the random codes to the communication data as well.

Even though the sensing signals from different base stations may also be randomized/orthogonal in the frequency domain for frequency domain processing and also randomized in the sequence domain, still, for time domain processing, due to coherent integration/addition in the time direction, there may be some interference. In some embodiments, to mitigate the interference between the signals of multiple base stations (e.g., between the base station 1310 and the base station 1312 in FIG. 13), the sensing symbols (e.g., across the sensing block duration) can be multiplied by a slow-time code or and orthogonal cover code (e.g., with a Hadamard code, or other random codes) to introduce a random phase in the time direction. In FIG. 13, the box 1328 is meant to indicate that sensing symbols 1332 are multiplied by a random code.

Further, the random code used for different base stations is different in some embodiments. The box 1330 indicates that the sensing symbols 1334 are multiplied by another random code which is different from the random code used for the sensing symbols 1332. By performing the random coding, for the Doppler FFT processing at the base station 1310, the interference from the base station 1312 creates a noise floor for base station 1310, in some embodiments, does not add coherently to its sensing signal. On the other hand, for the base station 1314, the sensing signal 1336 is not overlapping and interfering with the sensing signals 1332 and 1334 from base stations 1310 and 1312, respectively, since a separation in the time domain is provided between their sensing signals.

Another advantage of code-domain separation of sensing signals is the improvement to the sensing signal's signal-to-noise ratio (SNR) that comes from long codes and large sequences of the SRI. As described above, the sensing signal can be much weaker than the communication signals. To achieve adequate SNR in the sensing signal, repetition of the sensing signal is performed to average down the noise, in some embodiments. While it is possible to simply repeat the same sensing signal multiple times to achieve the necessary SNR, more effective approaches also exist. In some embodiments, coding is applied to the sensing signal in place of repetition to improve the SNR. Increasing the length of the slow-time code or the orthogonal code both increases the SNR of the sensing signal by repeating the number of sensing signal samples, and increases the isolation to inter-cell interference since longer orthogonal codes have better orthogonality/isolation properties.

This method of code-domain multiplexing can also be applicable to the co-site inter-sector cellular system setting accordingly, as illustrated at the bottom of FIG. 13. The signals from base station 1320 and base station 1324 can potentially interfere directly with each other. As such, these base stations need time (and/or frequency) domain separation/multiplexing of their signal transmission or spatial domain separation, as described above (which may also be combined with code-domain separation). This is because the slow-time coding, alone, may not be adequate for mitigating the interference when the sensing signal transmitted by the base station 1320 (with one pathloss) directly interferes with the echoed sensing signal of the base station 1324 (with potentially double the pathloss).

On the other hand, for interference mitigation between the base stations 1316 and 1318 (or between the base stations 1322 and 1324), where enough spatial domain separation is already available/possible (e.g., the transmit and reflection/interference FoVs between them may be separated), the above approach of slow-time coding (or other forms of code-domain multiplexing, potentially combined with spatial domain multiplexing methods described herein) can be applied to manage the interference (e.g., even if the signal from these two entities are transmitted over same time and frequency resources, e.g., without using an FD-comb structure over the same OFDM symbols). Sensing signal from the base station 1316 is facing a different direction than the base station 1318, and its signal will come to the base station 1318 as a reflection as well. If it even ever comes to the base station 1318, the sensing signal from base station 1316 is not a direct interference. As such, depending on the placements of base stations, the cell mapping, and the desired FoVs to be sensed, there is no need to have mutually exclusive time or frequency resources everywhere. Since some of the cells or sections of cells or FoVs or directions only interfere with the reflected signals, and some will interfere directly, they can be handled separately, e.g., by using different techniques for different types of interferences.

For positioning, the number of directions to be covered, e.g., the number of PRS resources within a PRS resource set, depends on deployments and applications/use cases, and would be up to the network implementation (across next generation RAN nodes and location management function (LMF)). The location of the base stations, their antenna configurations, coordination between base stations (e.g., it is desirable to ensure that a target UE is within the convex hull defined by a set of base stations), UE distribution, target coverage, surrounding environment, use cases, etc., are all factors that can be used to determine beamforming decisions for the positioning reference signal.

### Handling Inter-Cell Interference for Sensing at Multiple Dimensions

As discussed herein, different tools and mechanisms are supported and made available for the purpose of inter-cell interference handling, in some embodiments. Depending on the scenario, any one or a combination of these tools is applied (similar to handling interference for DL-PRS and other existing reference signal, which is achieved via a combination of different tools). At a high-level, the following can be summarized:
To provide orthogonality and isolation for mitigation of inter-cell intereference which degrades the sensing performance, frequency domain multiplexing through a comb structure can be used for assigning resources to different sensing base stations (especially if they are direct interferes to each others' sensing signals).
In addition, selective (time-domain) muting can provide additional orthogonality and isolation for inter-cell interference. This approach manages transmission of sensing and/or communication signals from other cells over the same or overlapping time resources. Muting can be applicable to other cells' sensing signal (e.g., when the number of sensing cells in an interfering neighborhood is larger than the maximum comb size), or can be applicable to other cells' communication signal.
Over the same OFDM symbol, only sensing signals from multiple cells may be transmitted (unless a cell is really far away so that interference is not an issue, or the communication transmission is orthogonal in the spatial and/or code domains to the sensing signal transmitted over the same OFDM symbol). The sensing signals from these multiple cells are frequency division multiplexed over different subcarriers.
In generation of the sensing signal, physical network sequences with proper initialization are used to provide an additional layer of randomization and separation for better sensing detection performance.
Approaches for spatial domain separation, potentially combined with code-domain separation/orthogonality are also beneficial, which can also increase the resource use efficiency while handling interference. Such approaches can be applied, in combination with each other or with time and/or frequency separation as well, depending on the deployment scenario, etc.

In some embodiments, the different disclosed signals multiplexing schemes can be configured either periodically or triggered based on certain events such as obtaining certain measurements, etc., or a combination of both.

Most of these approaches to handle/mitigate inter-cell interference involve coordination between base stations. In some embodiments, the base stations involved in the sensing process (including the ones performing the sensing as well as the ones in their neighborhood) coordinate with one another in order to collectively select and apply one or multiple of the disclosed signal multiplexing schemes.

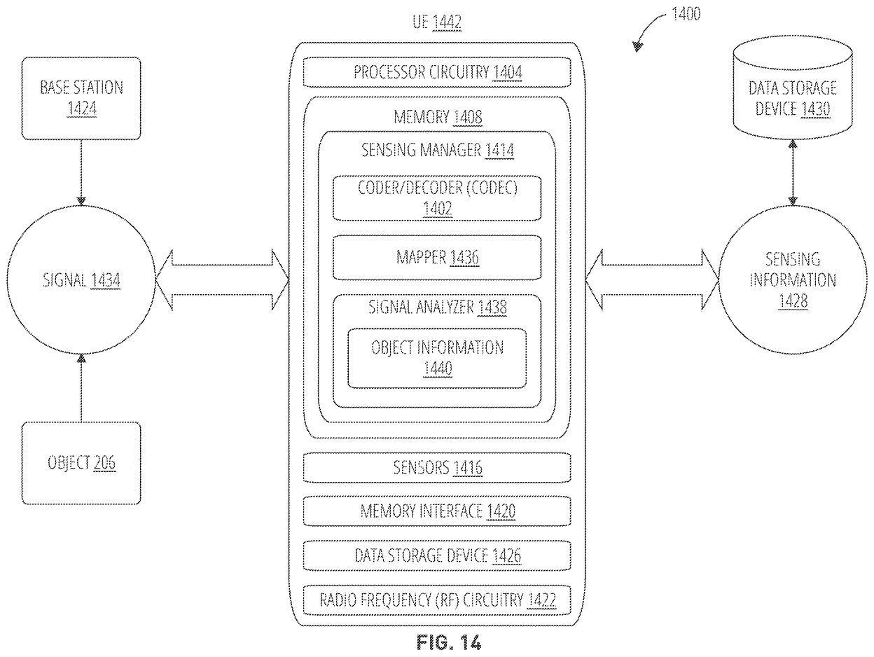

FIG. 14 illustrates an apparatus 1400 suitable for implementation as a UE 1442 in the wireless communications system 1900. The UE 1442 may operate as defined by various 3GPP Standards or non-3GPP standards. In one embodiment, the UE 1442 may implement a sensing entity. A sensing entity is any device capable of performing JCAS operations as discussed herein. Embodiments are not limited in this context.

As depicted in FIG. 14, the apparatus 1400 may comprise a processor circuitry 1404, a memory 1408 with a sensing manager 1414, one or more sensors 1416, a memory interface 1420, a data storage device 1426, and radio-frequency (RF) circuitry 1422. Examples of sensors 1416 may include sensors capable of collecting geospatial data associated with the UE 1442 using any number or type of suitable sensors and associated software and algorithms, such as a GPS system, a gyroscope sensor, an accelerometer, a magnetometer, a barometer, a camera, a light detection and ranging (LIDAR) sensor, a radio detection and ranging (RADAR) sensor, a proximity sensor, and so forth. Embodiments are not limited to these examples. The apparatus 1400 may optionally include a set of platform components (not shown) suitable for a UE 1902a, such as input/output devices, memory controllers, different memory types, network interfaces, hardware ports, and so forth.

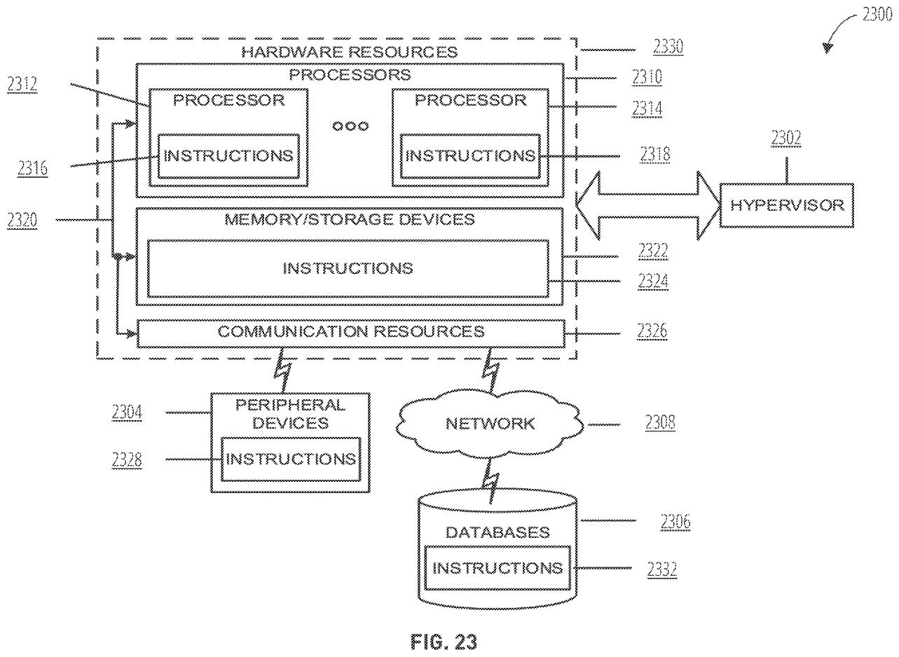

The apparatus 1400 for the UE 1442 may include the memory interface 1420. The memory interface 1420 may be arranged to send or receive, to or from a data storage device 1426 or a data storage device 1430, sensing information 1428 for a 5G or 6G NR system. The data storage device 1430 may be located external to the UE 1442 (off-device) and the data storage device 1426 may be located internal to the UE 1442 (on-device). When the data storage device 1426 is implemented on-device, the data storage device 1426 may comprise volatile or non-volatile memory, as described in more detail with reference to FIG. 23.

The apparatus 1400 may include processor circuitry 1404 communicatively coupled to the memory 1408, the memory interface 1420, the data storage device 1426 and the RF circuitry 1422. The memory 1408 may store instructions that when executed by the processor circuitry 1404 may implement or manage a sensing manager 1414 for the UE 1442. The sensing manager 1414 may include a coder/decoder (codec), such as the codec 1402. The codec 1402 may encode and decode messages to and from the base station 1424.

The sensing manager 1414 may manage JCAS operations in accordance with sensing information 1428. This may include receiving a signal 1434 from the base station 1424 and/or an object 206. An example of a signal 1434 received from the base station 1424 may comprise a signal carrying the sensing information 1428. Another example may comprise communication signals from the base station 1424 carrying control and/or data signals. An example of a signal 1434 may comprise a reflection signal reflected off of the object 206, where the reflection signal is a reflection of a sensing signal transmitted by the base station 1424.

The processor circuitry 1404 may execute instructions for a sensing entity to map a first set of sensing modulated symbols to time and frequency resources of an orthogonal frequency division multiplexing (OFDM) resource grid such that the first set of sensing modulated symbols are based on a pseudo-random (PN) sequence that is pseudo-orthogonal to a PN sequence used for a second set of modulated symbols; and encode a sensing signal comprising the mapped first set of sensing modulated symbols.

In one embodiment, for example, the PN sequence for the first set of sensing modulated signals is pseudo-orthogonal to a scrambling sequence used for the second set of modulated symbols, the scrambling sequence to scramble different communication channels.

In one embodiment, for example, orthogonal cover codes are applied to the sensing signal.

In one embodiment, for example, the first set of sensing modulated symbols and the second set of modulated symbols mapped across corresponding sensing block durations are multiplied by a slow-time code or orthogonal cover code, and wherein a random phase in a time domain is applied to the first set of sensing modulated symbols and the second set of modulated symbols.

In one embodiment, for example, the processor circuitry 1404 may map sensing modulated symbols to time and frequency resources of an orthogonal frequency division multiplexing (OFDM) resource grid of a fifth generation (5G) new radio (NR) downlink (DL) positioning reference signal (PRS), where the DL-PRS configuration supports a time domain separation between a first modulated signal of the sensing entity and a second modulated signal of a second sensing entity, the time domain separation realized by muting the second modulated signal for a duration of multiple symbols, multiple slots, or multiple subframes; and mute at least one of the DL PRS or a communication signal over a set of time resources.

In one embodiment, for example, a configuration of the DL PRS supports each PRS resource repetition in a PRS resource set instance to be individually muted.

In one embodiment, for example, a configuration of the DL PRS supports a subset of symbols in a multi-symbol PRS resource, or each intra-resource level repetition of PRS, to be muted while remaining symbols in the same multi-symbol PRS resource are transmitted.

In one embodiment, for example, a set of muting parameters are defined as part of a PRS resource configuration.

In one embodiment, for example, muting parameters are configured or overrode via a Downlink Control Information (DCI) channel.

In one embodiment, for example, the DCI channel indicates at least one of the initiation or the cessation of the muting operation.

In one embodiment, for example, the processor circuitry to mute slots or OFDM symbols and mutes sensing or data transmission of the second sensing entity, resulting in time domain multiplexing between cell entities or between sections covered by the second sensing entity.

One embodiment, for example, includes a bitmap related to a DL-PRS Muting Pattern parameter, wherein corresponding to each bit in the bitmap of the DL-PRS Muting Pattern parameter, another parameter is defined for each PRS resource within the PRS resource set to indicate whether a repetition of the PRS resource is transmitted.

In one embodiment, for example, the configuration of DL PRS further comprises a bitmap where each bit in the bitmap indicates transmission of each resource for a given repetition index.

In one embodiment, for example, a PRS resource configuration parameter, dl-PRS-MutingPatternForResource, defines the symbol locations where part of the DL PRS resource is expected to not be transmitted.

In one embodiment, for example, the sensing entity further comprises one or more sensing transmit beams, wherein impact areas of signal reflections of a target in a field of view (FoV) of the one or more sensing transmit beams are separated from second impact areas of the second sensing entity.

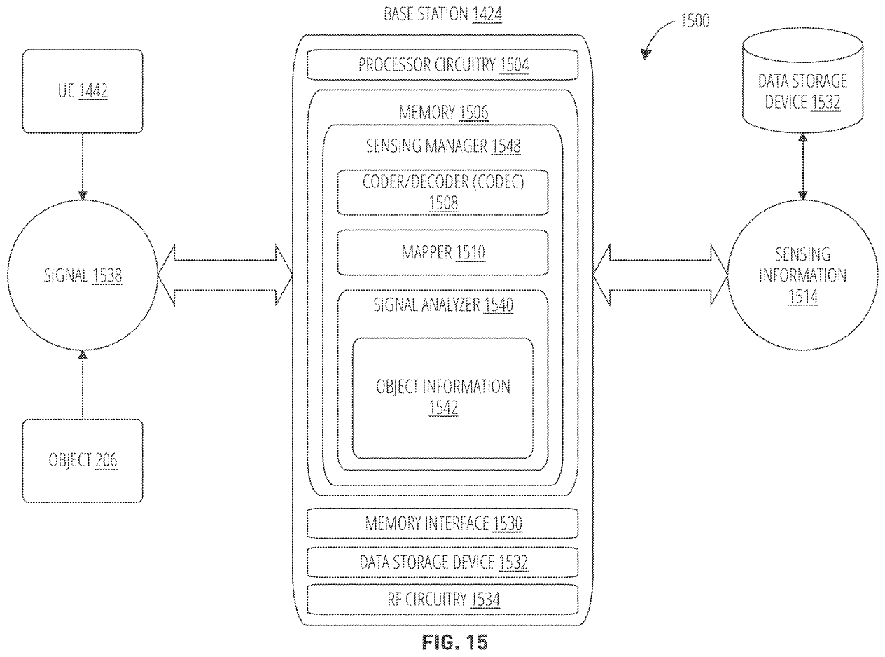

FIG. 15 illustrates an apparatus 1500 suitable for implementation as a base station 1424 in the wireless communications system 1900 and/or the wireless communications system 2000. The base station 1424 is an example of the gNB 2004. The base station 1424 may operate as defined by various 3GPP Standards or non-3GPP standards. In one embodiment, the base station 1424 may implement a sensing entity. A sensing entity is any device capable of performing JCAS operations as discussed herein. Embodiments are not limited in this context.

As depicted in FIG. 15, the apparatus 1500 may comprise a processor circuitry 1504, a memory 1506 with a sensing manager 2018, a memory interface 1530, a data storage device 1532, and RF circuitry 1534. The apparatus 1500 may optionally include a set of platform components (not shown) suitable for a UE 1442, such as input/output devices, memory controllers, different memory types, network interfaces, hardware ports, and so forth.

The sensing manager 2018 may comprise a codec 1508 and a mapper 1510. The sensing manager 2018 may manage JCAS operations in accordance with sensing information 1514. This may include receiving a signal 1538 from the UE 1442 and/or an object 206. An example of a signal 1538 received from the UE 1442 may comprise a signal carrying the sensing information 1514. Another example may comprise communication signals from the UE 1442 carrying control and/or data signals. An example of a signal 1538 may comprise a reflection signal reflected off of the object 206, where the reflection signal is a reflection of a sensing signal transmitted by the UE 1442.

In one embodiment, the apparatus 1500 may be implemented for the base station 1424. The base station 1424 includes a memory interface 1530 to send or receive, to or from a data storage device 1532, sensing information 1514 for a wireless communications system 1900 or a wireless communications system 2000. The base station 1424 also includes processor circuitry 1504 communicatively coupled to the memory interface 1530, the processor circuitry 1504 to execute instructions for a sensing entity, to map a first set of sensing modulated symbols to time and frequency resources of an orthogonal frequency division multiplexing (OFDM) resource grid, wherein the first set of sensing modulated symbols are mapped to a set of comb-structured subcarriers over one or more consecutive OFDM symbols to reduce interference with a second set of modulated symbols within a same frequency bandwidth; and encode a sensing signal comprising the mapped first set of sensing modulated symbols.

In one embodiment, for example, the processor circuitry to decode a reflection signal based on the sensing signal, the reflection signal to comprise a reflection of the sensing signal from an object.

In one embodiment, for example, the processor circuitry to analyze the reflection signal to determine an identity of the object, a location of the object, a range of the object, an angle of the object, or a velocity of the object.

In one embodiment, for example, the first set of sensing modulated symbols start from a different subcarrier offset than the second set of modulated symbols.

In one embodiment, for example, the first set of sensing modulated symbols are associated with the sensing entity and the second set of modulated symbols are associated with a second sensing entity, the second sensing entity comprising a base station.

In one embodiment, for example, the set of comb-structured subcarriers comprises a defined number of subcarriers that form a repeating pattern multiplexed over all subcarriers of a single physical resource block.

In one embodiment, for example, the apparatus 1500 may further comprise radio-frequency (RF) circuitry communicatively coupled to the processor circuitry, the RF circuitry to transmit the encoded sensing signal and receive a reflection signal associated with the encoded sensing signal as RF signals.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware element, a software element executed by a processor, or any combination thereof. The embodiments are not limited in this context.

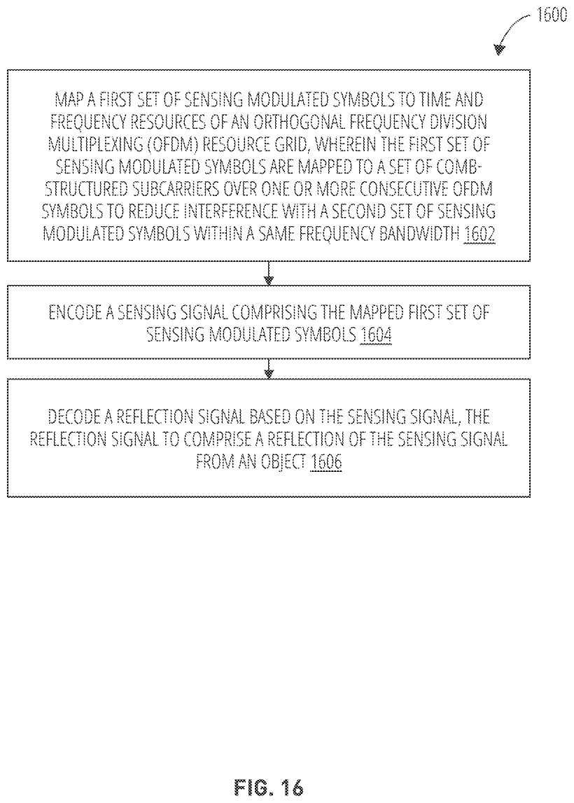

FIG. 16 illustrates an embodiment of a logic flow 1600. The logic flow 1600 may be representative of some or all of the operations executed by one or more embodiments described herein. For example, the logic flow 1600 may include some or all of the operations performed by devices or entities within the wireless communications system 1900 and/or the wireless communications system 2000, such as the UE 1442 or the base station 1424. Embodiments are not limited in this context.

In block 1602, the logic flow 1600 maps a first set of sensing modulated symbols to time and frequency resources of an orthogonal frequency division multiplexing (OFDM) resource grid, wherein the first set of sensing modulated symbols are mapped to a set of comb-structured subcarriers over one or more consecutive OFDM symbols to reduce interference with a second set of modulated symbols within a same frequency bandwidth. In block 1604, the logic flow 1600 encodes a sensing signal comprising the mapped first set of sensing modulated symbols. In block 1606, the logic flow 1600 decodes a reflection signal based on the sensing signal, the reflection signal to comprise a reflection of the sensing signal from an object.

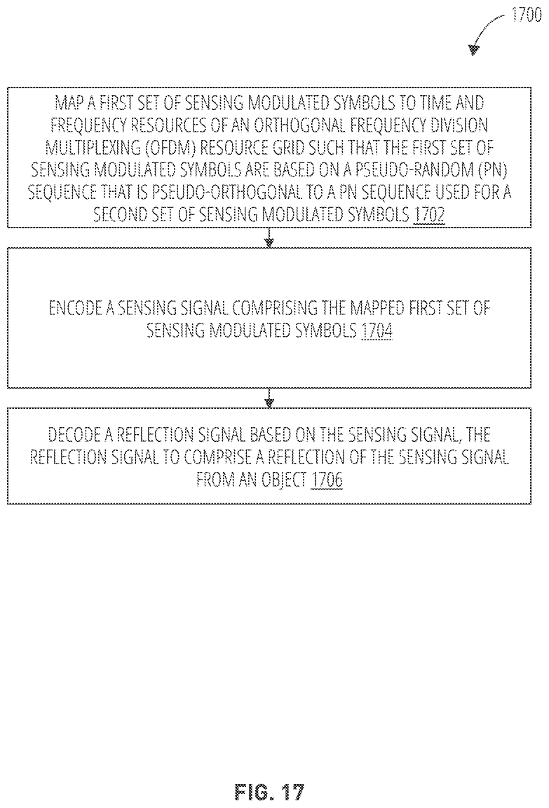

FIG. 17 illustrates an embodiment of a logic flow 1700. The logic flow 1700may be representative of some or all of the operations executed by one or more embodiments described herein. For example, the logic flow 1700 may include some or all of the operations performed by devices or entities within the wireless communications system 1900 and/or the wireless communications system 2000, such as the UE 1442 or the base station 1424. Embodiments are not limited in this context.

In block 1702, the logic flow 1700 may execute instructions for a sensing entity to map a first set of sensing modulated symbols to time and frequency resources of an orthogonal frequency division multiplexing (OFDM) resource grid such that the first set of sensing modulated symbols are based on a pseudo-random (PN) sequence that is pseudo-orthogonal to a PN sequence used for a second set of modulated symbols. In block 1704, the logic flow 1700 may encode a sensing signal comprising the mapped first set of sensing modulated symbols. In block 1706, the logic flow 1700 may decode a reflection signal based on the sensing signal, the reflection signal to comprise a reflection of the sensing signal from an object.

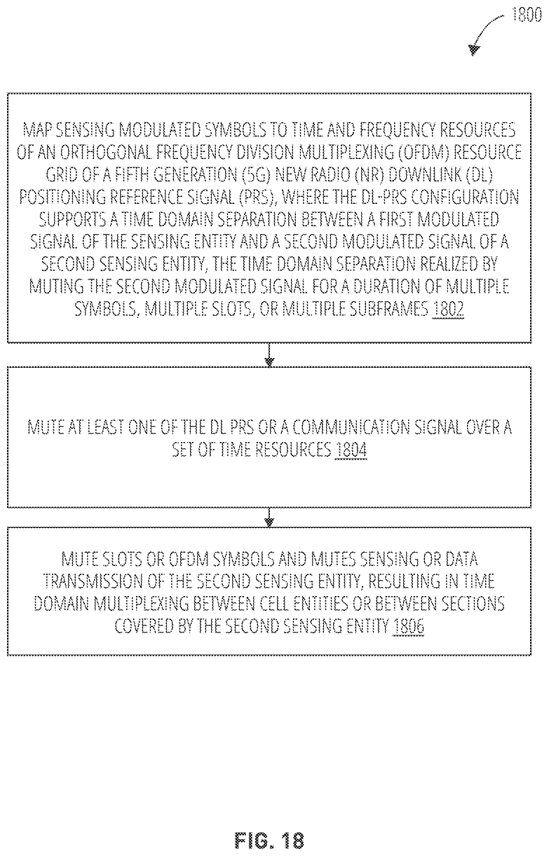

FIG. 18 illustrates an embodiment of a logic flow 1800. The logic flow 1800may be representative of some or all of the operations executed by one or more embodiments described herein. For example, the logic flow 1800 may include some or all of the operations performed by devices or entities within the wireless communications system 1900 and/or the wireless communications system 2000, such as the UE 1442 or the base station 1424. Embodiments are not limited in this context.

In block 1802, the logic flow 1800 may map sensing modulated symbols to time and frequency resources of an orthogonal frequency division multiplexing (OFDM) resource grid of a fifth generation (5G) new radio (NR) downlink (DL) positioning reference signal (PRS), where the DL-PRS configuration supports a time domain separation between a first modulated signal of the sensing entity and a second modulated signal of a second sensing entity, the time domain separation realized by muting the second modulated signal for a duration of multiple symbols, multiple slots, or multiple subframes. In block 1804, the logic flow 1800 may mute at least one of the DL PRS or a communication signal over a set of time resources. In block 1806, the logic flow 1800 may mute slots or OFDM symbols and mutes sensing or data transmission of the second sensing entity, resulting in time domain multiplexing between cell entities or between sections covered by the second sensing entity.

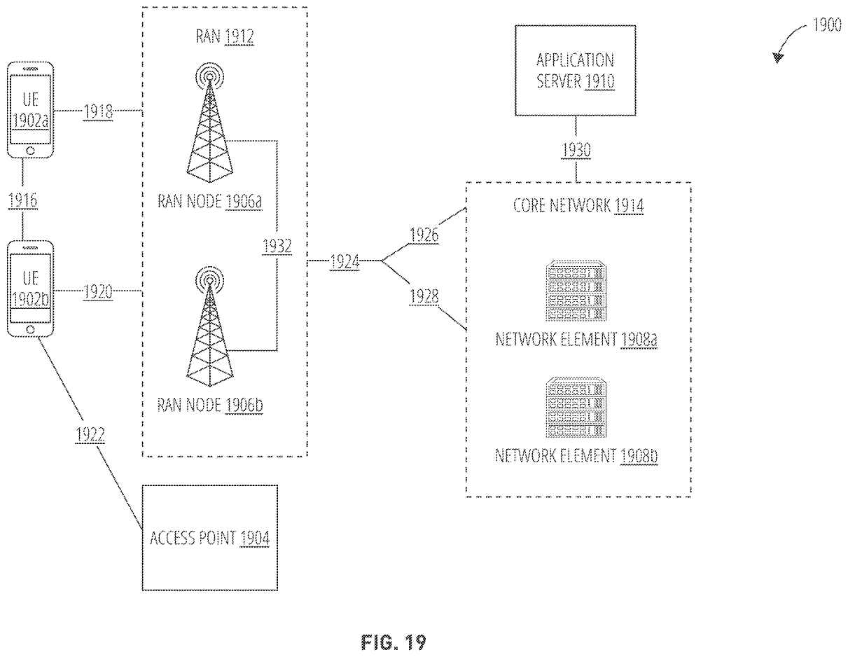

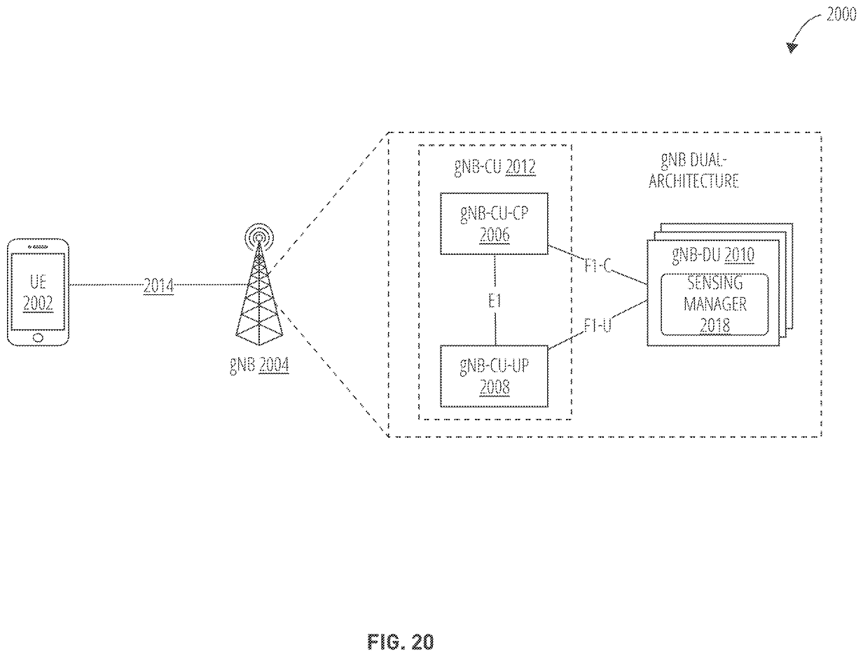

FIG. 19 illustrates an example of a wireless communication wireless communications system 1900. For purposes of convenience and without limitation, the example wireless communications system 1900 is described in the context of the long-term evolution (LTE) and fifth generation (5G) new radio (NR) (5G NR) cellular networks communication standards as defined by one or more 3GPP TS 38.133 Standards, 3GPP TS 38.304 Standards, 3GPP 38.331 Standards, or 3GPP 38.1400 Standards, or other 3GPP standards or specifications. However, other types of wireless standards are possible as well.

The wireless communications system 1900 supports two classes of UE devices, including a reduced capability (RedCap) UE 1902a and standard UE 1902b (collectively referred to as the “UEs 102”). In one embodiment, the UE 1902a may have a set of one or more reduced capabilities relative to a set of standard capabilities of the standard UE 1902b. Examples of reduced capabilities may include without limitation: (1) 20 megahertz (MHz) in sub-7 gigahertz (GHz) or 1900 MHz in millimeter wave (mmWave) frequency bands; (2) a single transmit (Tx) antenna (1 Tx); (3) a single receive (Rx) antenna (1 Rx), with 2 antennas (2 Rx) being optional; (4) optional support for half-duplex FDD; (5) lower-order modulation, with 256-quadrature amplitude modulation (QAM) being optional; and (6) support for lower transmit power. In one embodiment, for example, the standard UE 1902b may have a 2 Rx antenna, while the UE 1902a may only have a 1 Rx antenna. The UE 1902a may have other reduced capabilities as well. Embodiments are not limited in this context.

In this example, the UEs 102 are illustrated as smartphones (e.g., handheld touchscreen mobile computing devices connectable to one or more cellular networks). In other examples, any of the UEs 102 can include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IoT) devices, or combinations of them, among others.

In some implementations, any of the UEs 102 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which can include uniquely identifiable embedded computing devices (within the Internet infrastructure), with short-lived connections. The IoT UEs may execute background applications (e.g., keep-alive messages or status updates) to facilitate the connections of the IoT network.

The UEs 102 are configured to connect (e.g., communicatively couple) with a radio access network (RAN) 1912. In some implementations, the RAN 1912 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 1912 that operates in a 5G NR wireless communications system 1900, and the term “E-UTRAN” may refer to a RAN 1912 that operates in an LTE or 4G wireless communications system 1900.

To connect to the RAN 1912, the UEs 102 utilize connections (or channels) 1918 and 1920, respectively, each of which can include a physical communications interface or layer, as described below. In this example, the connections 1918 and 1920 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The UE 1902b is shown to be configured to access an access point (AP) 1904 (also referred to as “WLAN node 1904,” “WLAN 1904,” “WLAN Termination 1904,” “WT 1904” or the like) using a connection 1922. The connection 1922 can include a local wireless connection, such as a connection consistent with any IEEE 802.11 protocol, in which the AP 1904 would include a wireless fidelity (Wi-Fi) router. In this example, the AP 1904 is shown to be connected to the Internet without connecting to the core network of the wireless system, as described in further detail below.

The RAN 1912 can include one or more nodes such as RAN nodes 1906a and 1906b (collectively referred to as “RAN nodes 106” or “RAN node 106”) that enable the connections 1918 and 1920. As used herein, the terms “access node,” “access point,” or the like may describe equipment that provides the radio baseband functions for data or voice connectivity, or both, between a network and one or more users. These access nodes can be referred to as base stations (BS), gNodeBs, gNBs, eNodeBs, eNBs, NodeBs, RAN nodes, rode side units (RSUs), transmission reception points (TRxPs or TRPs), and the link, and can include ground stations (e.g., terrestrial access points) or satellite stations providing coverage within a geographic area (e.g., a cell), among others. As used herein, the term “NG RAN node” may refer to a RAN node 106 that operates in an 5G NR wireless communications system 1900 (for example, a gNB), and the term “E-UTRAN node” may refer to a RAN node 106 that operates in an LTE or 4G wireless communications system 1900 (e.g., an eNB). In some implementations, the RAN nodes 106 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

In some implementations, some or all of the RAN nodes 106 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 106; a medium access control (MAC)/physical layer (PHY) split in which RRC, PDCP, MAC, and radio link control (RLC) layers are operated by the CRAN/vBBUP and the PHY layer is operated by individual RAN nodes 106; or a “lower PHY” split in which RRC, PDCP, RLC, and MAC layers and upper portions of the PHY layer are operated by the CRAN/vBBUP and lower portions of the PHY layer are operated by individual RAN nodes 106. This virtualized framework allows the freed-up processor cores of the RAN nodes 106 to perform, for example, other virtualized applications. In some implementations, an individual RAN node 106 may represent individual gNB distributed units (DUs) that are connected to a gNB central unit (CU) using individual F1 interfaces (not shown in FIG. 19). In some implementations, the gNB-DUs can include one or more remote radio heads or RFEMs, and the gNB-CU may be operated by a server that is located in the RAN 1912 (not shown) or by a server pool in a similar manner as the CRAN/vBBUP. Additionally or alternatively, one or more of the RAN nodes 106 may be next generation eNBs (ng-eNBs), including RAN nodes that provide E-UTRA user plane and control plane protocol terminations toward the UEs 102, and are connected to a 5G core network (e.g., core network 1914) using a next generation interface.

In vehicle-to-everything (V2X) scenarios, one or more of the RAN nodes 106 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 102 (vUEs 102). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and can include a network interface controller to provide a wired connection (e.g., Ethernet) to a traffic signal controller or a backhaul network, or both.

Any of the RAN nodes 106 can terminate the air interface protocol and can be the first point of contact for the UEs 102. In some implementations, any of the RAN nodes 106 can fulfill various logical functions for the RAN 1912 including, but not limited to, radio network controller (RNC) functions such as radio bearer management, uplink and downlink dynamic radio resource management and data packet scheduling, and mobility management.

In some implementations, the UEs 102 can be configured to communicate using orthogonal frequency division multiplexing (OFDM) communication signals with each other or with any of the RAN nodes 106 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

The RAN nodes 106 can transmit to the UEs 102 over various channels. Various examples of downlink communication channels include Physical Broadcast Channel (PBCH), Physical Downlink Control Channel (PDCCH), and Physical Downlink Shared Channel (PDSCH). Other types of downlink channels are possible. The UEs 102 can transmit to the RAN nodes 106 over various channels. Various examples of uplink communication channels include Physical Uplink Shared Channel (PUSCH), Physical Uplink Control Channel (PUCCH), and Physical Random Access Channel (PRACH). Other types of uplink channels are possible.

In some implementations, a downlink resource grid can be used for downlink transmissions from any of the RAN nodes 106 to the UEs 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The PDSCH carries user data and higher-layer signaling to the UEs 102. The PDCCH carries information about the transport format and resource allocations related to the PDSCH channel, among other things. It may also inform the UEs 102 about the transport format, resource allocation, and hybrid automatic repeat request (HARQ) information related to the uplink shared channel. Downlink scheduling (e.g., assigning control and shared channel resource blocks to the UE 1902b within a cell) may be performed at any of the RAN nodes 106 based on channel quality information fed back from any of the UEs 102. The downlink resource assignment information may be sent on the PDCCH used for (e.g., assigned to) each of the UEs 102.

The PDCCH uses control channel elements (CCEs) to convey the control information. Before being mapped to resource elements, the PDCCH complex-valued symbols may first be organized into quadruplets, which may then be permuted using a sub-block interleaver for rate matching. In some implementations, each PDCCH may be transmitted using one or more of these CCEs, in which each CCE may correspond to nine sets of four physical resource elements collectively referred to as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. In LTE, there can be four or more different PDCCH formats defined with different numbers of CCEs (e.g., aggregation level, L=1, 2, 4, or 8).

Some implementations may use concepts for resource allocation for control channel information that are an extension of the above-described concepts. For example, some implementations may utilize an enhanced PDCCH (EPDCCH) that uses PDSCH resources for control information transmission. The EPDCCH may be transmitted using one or more enhanced CCEs (ECCEs). Similar to above, each ECCE may correspond to nine sets of four physical resource elements collectively referred to as an enhanced REG (EREG). An ECCE may have other numbers of EREGs.

The RAN nodes 106 are configured to communicate with one another using an interface 1932. In examples, such as where the wireless communications system 1900 is an LTE system (e.g., when the core network 1914 is an evolved packet core (EPC) network), the interface 1932 may be an X2 interface 1932. The X2 interface may be defined between two or more RAN nodes 106 (e.g., two or more eNBs and the like) that connect to the EPC 1914, or between two eNBs connecting to EPC 1914, or both. In some implementations, the X2 interface can include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 102 from a secondary eNB for user data; information of PDCP PDUs that were not delivered to a UE 102; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionality.

In some implementations, such as where the wireless communications system 1900 is a 5G NR system (e.g., when the core network 1914 is a 5G core network), the interface 1932 may be an Xn interface 1932. The Xn interface may be defined between two or more RAN nodes 106 (e.g., two or more gNBs and the like) that connect to the 5G core network 1914, between a RAN node 106 (e.g., a gNB) connecting to the 5G core network 1914 and an eNB, or between two eNBs connecting to the 5G core network 1914, or combinations of them. In some implementations, the Xn interface can include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 102 in a connected mode (e.g., CM-CONNECTED) including functionality to manage the UE mobility for connected mode between one or more RAN nodes 106, among other functionality. The mobility support can include context transfer from an old (source) serving RAN node 106 to new (target) serving RAN node 106, and control of user plane tunnels between old (source) serving RAN node 106 to new (target) serving RAN node 106. A protocol stack of the Xn-U can include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack can include an application layer signaling protocol (referred to as Xn Application Protocol (Xn-AP or XnAP)) and a transport network layer (TNL) that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 1912 is shown to be communicatively coupled to a core network 1914 (referred to as a “CN 1914”). The CN 1914 includes multiple network elements, such as network element 108a and network element 1908b (collectively referred to as the “network elements 108”), which are configured to offer various data and telecommunications services to customers/subscribers (e.g., users of UEs 102) who are connected to the CN 1914 using the RAN 1912. The components of the CN 1914 may be implemented in one physical node or separate physical nodes and can include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 1914 may be referred to as a network slice, and a logical instantiation of a portion of the CN 1914 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 1910 may be an element offering applications that use IP bearer resources with the core network (e.g., UMTS packet services (PS) domain, LTE PS data services, among others). The application server 1910 can also be configured to support one or more communication services (e.g., VOIP sessions, PTT sessions, group communication sessions, social networking services, among others) for the UEs 102 using the CN 1914. The application server 1910 can use an IP communications interface 1930 to communicate with one or more network elements 1908a.

In some implementations, the CN 1914 may be a 5G core network (referred to as “5GC 1914” or “5G core network 1914”), and the RAN 1912 may be connected with the CN 1914 using a next generation interface 1924. In some implementations, the next generation interface 1924 may be split into two parts, a next generation user plane (NG-U) interface 1914, which carries traffic data between the RAN nodes 106 and a user plane function (UPF), and the S1 control plane (NG-C) interface 1926, which is a signaling interface between the RAN nodes 106 and access and mobility management functions (AMFs). Examples where the CN 1914 is a 5G core network are discussed in more detail with regard to later figures.

In some implementations, the CN 1914 may be an EPC (referred to as “EPC 1914” or the like), and the RAN 1912 may be connected with the CN 1914 using an S1 interface 1924. In some implementations, the S1 interface 1924 may be split into two parts, an S1 user plane (S1-U) interface 1928, which carries traffic data between the RAN nodes 106 and the serving gateway (S-GW), and the S1-MME interface 1926, which is a signaling interface between the RAN nodes 106 and mobility management entities (MMEs).

As previously discussed, in some implementations, an individual RAN node 106 may be implemented as a gNB dual-architecture comprising multiple gNB-DUs that are connected to a gNB-CU using individual F1 interfaces. An example of a gNB dual-architecture for a RAN node 106 is shown in FIG. 20.

FIG. 20 illustrates wireless communications system 2000. The wireless communications system 2000 is a sub-system of the wireless communications system 1900 illustrated in FIG. 19. The wireless communications system 2000 depicts a UE 2002 connected to a gNB 2004 over a connection 2014. The UE 2002 and connection 2014 are similar to the UE 102 and the connections 1918, 1920 described with reference to FIG. 1. The gNB 2004 is similar to the RAN node 106, and represents an implementation of the RAN node 106 as a gNB with a dual-architecture.

As depicted in FIG. 20, the gNB 2004 is divided into two physical entities referred to a centralized or central unit (CU) and a distributed unit (DU). The gNB 2004 may comprise a gNB-CU 2012 and one or more gNB-DU 2010. The gNB-CU 2012 is further divided into a gNB-CU control plane (gNB-CU-CP) 2006 and a gNB-CU user plane (gNB-CU-UP) 2008. The gNB-CU-CP 2006 and the gNB-CU-UP 2008 communicate over an E1 interface. The gNB-CU-CP 2006 communicates with one or more gNB-DU 2010 over an F1-C interface. The gNB-CU-UP 2008 communicates with the one or more gNB-DU 2010 over an F1-U interface.

In some implementations, there is a single gNB-CU 2012 for each gNB 2004 that controls multiple gNB-DU 2010. For example, the gNB 2004 may have more than 1900 gNB-DU 2010 connected to a single gNB-CU 2012. Each gNB-DU 2010 is able to support one or more cells, where one gNB 2004 can potentially control hundreds of cells in a 5G NR system.

The gNB-CU 2012 is mainly involved in controlling and managing the overall network operations, performing tasks related to the control plane, such as connection establishment, mobility management, and signaling. It is responsible for non-real-time functionalities, which include policy decisions, routing, and session management among others. The gNB-CU-CP 2006 and the gNB-CU-UP 2008 provides support for higher layers of a protocol stack such as Service Data Adaptation Protocol (SDAP), Packet Data Convergence Protocol (PDCP) and RRC.

The gNB-DU 2010 is responsible for real-time, high-speed functions, such as the scheduling of radio resources, managing the data plane, and performing error handling and retransmissions. The gNB-DU 2010 provides support for lower layers of the protocol stack such as Radio Link Control (RLC), MAC layer, and PHY layer.

As depicted in FIG. 20, the gNB-DU 2010 includes a sensing manager 2018. In the wireless communications system 1900 and/or the wireless communications system 2000, scheduling of measurement gaps for UE 2002, including their configuration and allocation, is primarily handled by the base station of the serving cell, by the sensing manager 2018. The sensing manager 2018 is involved in real-time operations and is responsible for making immediate decisions regarding the allocation of radio resources, managing interference, and adhering to Quality of Service (QoS) requirements for different services and users. The sensing manager 2018 within the gNB-DU 2010 makes decisions about resource allocation, including when and how to schedule measurement gaps for the UE 2002. It considers the capabilities of the UE 2002, mobility state, quality of service requirements, and current network conditions, among other factors.

Based on scheduling decisions, the gNB-DU 2010 sends configuration information to the UE 2002, instructing it when to perform measurements by allocating specific time intervals as measurement gaps. This information is usually conveyed through Radio Resource Control (RRC) messages, such as RRC Reconfiguration messages, among other types of messages. The RRC layer is responsible for managing the signaling between the UE 2002 and the gNB-DU 2010, including the signaling related to the configuration of measurement gaps. The RRC layer in the gNB-DU 2010 thus plays a crucial role in orchestrating the scheduling and allocation of measurement gaps based on decisions made by the sensing manager 2018. After receiving the configuration, the UE 2002 performs measurements during the allocated gaps and reports the results back to the network, enabling the gNB-DU 2010 to make further decisions, such as handovers or beam adjustments.

Although the scheduler is located within the gNB-DU, it frequently interacts with the gNB-CU. The gNB-CU provides the necessary control and configuration information to the gNB-DU, which it uses to make real-time scheduling decisions and manage radio resources effectively. The configuration, policies, and user-specific QoS parameters provided by the gNB-CU aid the sensing manager 2018 in the gNB-DU to allocate resources and manage user traffic efficiently, catering to diverse service requirements in 5G and 6G networks.

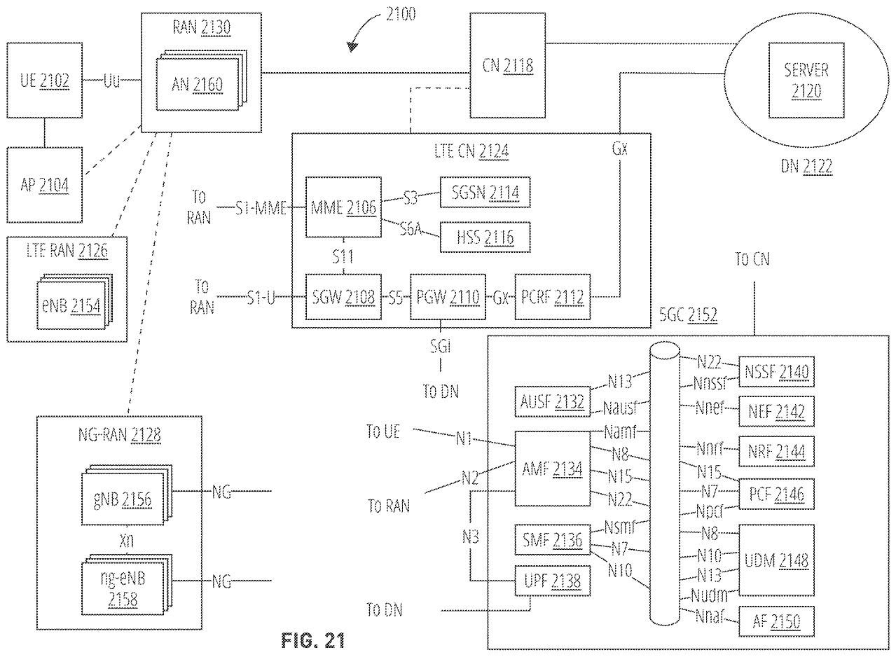

FIG. 21 illustrates a network 2100 in accordance with various embodiments. The network 2100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 2100 may include a UE 2102, which may include any mobile or non-mobile computing device designed to communicate with a RAN 2130 via an over-the-air connection. The UE 2102 may be communicatively coupled with the RAN 2130 by a Uu interface. The UE 2102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 2100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 2102 may additionally communicate with an AP 2104 via an over-the-air connection. The AP 2104 may manage a WLAN connection, which may serve to offload some/all network traffic from the RAN 2130. The connection between the UE 2102 and the AP 2104 may be consistent with any IEEE 2102.11 protocol, wherein the AP 2104 could be a wireless fidelity (Wi-Fi®) router. In some embodiments, the UE 2102, RAN 2130, and AP 2104 may utilize cellular-WLAN aggregation (for example, LWA/LWIP). Cellular-WLAN aggregation may involve the UE 2102 being configured by the RAN 2130 to utilize both cellular radio resources and WLAN resources.

The RAN 2130 may include one or more access nodes, for example, AN 2160. AN 2160 may terminate air-interface protocols for the UE 2102 by providing access stratum protocols including RRC, PDCP, RLC, MAC, and L1 protocols. In this manner, the AN 2160 may enable data/voice connectivity between CN 2118 and the UE 2102. In some embodiments, the AN 2160 may be implemented in a discrete device or as one or more software entities running on server computers as part of, for example, a virtual network, which may be referred to as a CRAN or virtual baseband unit pool. The AN 2160 be referred to as a BS, gNB, RAN node, eNB, ng-eNB, NodeB, RSU, TRxP, TRP, etc. The AN 2160 may be a macrocell base station or a low power base station for providing femtocells, picocells or other like cells having smaller coverage areas, smaller user capacity, or higher bandwidth compared to macrocells.

In embodiments in which the RAN 2130 includes a plurality of ANs, they may be coupled with one another via an X2 interface (if the RAN 2130 is an LTE RAN) or an Xn interface (if the RAN 2130 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 2130 may each manage one or more cells, cell groups, component carriers, etc. to provide the UE 2102 with an air interface for network access. The UE 2102 may be simultaneously connected with a plurality of cells provided by the same or different ANs of the RAN 2130. For example, the UE 2102 and RAN 2130 may use carrier aggregation to allow the UE 2102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 2130 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 2102 or AN 2160 may be or act as an RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 2130 may be an LTE RAN 2126 with eNBs, for example, eNB 2154. The LTE RAN 2126 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 2130 may be an NG-RAN 2128 with gNBs, for example, gNB 2156, or ng-eNBs, for example, ng-eNB 2158. The gNB 2156 may connect with 5G-enabled UEs using a 5G NR interface. The gNB 2156 may connect with a 5G core through an NG interface, which may include an N2 interface or an N3 interface. The ng-eNB 2158 may also connect with the 5G core through an NG interface, but may connect with a UE via an LTE air interface. The gNB 2156 and the ng-eNB 2158 may connect with each other over an Xn interface.

In some embodiments, the NG interface may be split into two parts, an NG user plane (NG-U) interface, which carries traffic data between the nodes of the NG-RAN 2128 and a UPF 2138 (e.g., N3 interface), and an NG control plane (NG-C) interface, which is a signaling interface between the nodes of the NG-RAN 2128 and an AMF 2134 (e.g., N2 interface).

The NG-RAN 2128 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 2102 can be configured with multiple BWPs where each BWP configuration has a different SCS. When a BWP change is indicated to the UE 2102, the SCS of the transmission is changed as well. Another use case example of BWP is related to power saving. In particular, multiple BWPs can be configured for the UE 2102 with different amount of frequency resources (for example, PRBs) to support data transmission under different traffic loading scenarios. A BWP containing a smaller number of PRBs can be used for data transmission with small traffic load while allowing power saving at the UE 2102 and in some cases at the gNB 2156. A BWP containing a larger number of PRBs can be used for scenarios with higher traffic load.

The RAN 2130 is communicatively coupled to CN 2118 that includes network elements to provide various functions to support data and telecommunications services to customers/subscribers (for example, users of UE 2102). The components of the CN 2118 may be implemented in one physical node or separate physical nodes. In some embodiments, NFV may be utilized to virtualize any or all of the functions provided by the network elements of the CN 2118 onto physical compute/storage resources in servers, switches, etc. A logical instantiation of the CN 2118 may be referred to as a network slice, and a logical instantiation of a portion of the CN 2118 may be referred to as a network sub-slice.

In some embodiments, the CN 2118 may be an LTE CN 2124, which may also be referred to as an EPC. The LTE CN 2124 may include MME 2106, SGW 2108, SGSN 2114, HSS 2116, PGW 2110, and PCRF 2112 coupled with one another over interfaces (or “reference points”) as shown. Functions of the elements of the LTE CN 2124 may be briefly introduced as follows.

The MME 2106 may implement mobility management functions to track a current location of the UE 2102 to facilitate paging, bearer activation/deactivation, handovers, gateway selection, authentication, etc.

The SGW 2108 may terminate an S1 interface toward the RAN and route data packets between the RAN and the LTE CN 2124. The SGW 2108 may be a local mobility anchor point for inter-RAN node handovers and also may provide an anchor for inter-3GPP mobility. Other responsibilities may include lawful intercept, charging, and some policy enforcement.

The SGSN 2114 may track a location of the UE 2102 and perform security functions and access control. In addition, the SGSN 2114 may perform inter-EPC node signaling for mobility between different RAT networks; PDN and S-GW selection as specified by MME 2106; MME selection for handovers; etc. The S3 reference point between the MME 2106 and the SGSN 2114 may enable user and bearer information exchange for inter-3GPP access network mobility in idle/active states.

The HSS 2116 may include a database for network users, including subscription-related information to support the network entities' handling of communication sessions. The HSS 2116 can provide support for routing/roaming, authentication, authorization, naming/addressing resolution, location dependencies, etc. An S6a reference point between the HSS 2116 and the MME 2106 may enable transfer of subscription and authentication data for authenticating/authorizing user access to the LTE CN 2118.

The PGW 2110 may terminate an SGi interface toward a data network (DN) 2122 that may include an application/content server 2120. The PGW 2110 may route data packets between the LTE CN 2124 and the data network 2122. The PGW 2110 may be coupled with the SGW 2108 by an S5 reference point to facilitate user plane tunneling and tunnel management. The PGW 2110 may further include a node for policy enforcement and charging data collection (for example, PCEF). Additionally, the SGi reference point between the PGW 2110 and the data network 2122 may be an operator external public, a private PDN, or an intra-operator packet data network, for example, for provision of IMS services. The PGW 2110 may be coupled with a PCRF 2112 via a Gx reference point.

The PCRF 2112 is the policy and charging control element of the LTE CN 2124. The PCRF 2112 may be communicatively coupled to the app/content server 2120 to determine appropriate QoS and charging parameters for service flows. The PCRF 2110 may provision associated rules into a PCEF (via Gx reference point) with appropriate TFT and QCI.

In some embodiments, the CN 2118 may be a 5GC 2152. The 5GC 2152 may include an AUSF 2132, AMF 2134, SMF 2136, UPF 2138, NSSF 2140, NEF 2142, NRF 2144, PCF 2146, UDM 2148, and AF 2150 coupled with one another over interfaces (or “reference points”) as shown. Functions of the elements of the 5GC 2152 may be briefly introduced as follows.

The AUSF 2132 may store data for authentication of UE 2102 and handle authentication-related functionality. The AUSF 2132 may facilitate a common authentication framework for various access types. In addition to communicating with other elements of the 5GC 2152 over reference points as shown, the AUSF 2132 may exhibit an Nausf service-based interface.

The AMF 2134 may allow other functions of the 5GC 2152 to communicate with the UE 2102 and the RAN 2130 and to subscribe to notifications about mobility events with respect to the UE 2102. The AMF 2134 may be responsible for registration management (for example, for registering UE 2102), connection management, reachability management, mobility management, lawful interception of AMF-related events, and access authentication and authorization. The AMF 2134 may provide transport for SM messages between the UE 2102 and the SMF 2136, and act as a transparent proxy for routing SM messages. AMF 2134 may also provide transport for SMS messages between UE 2102 and an SMSF. AMF 2134 may interact with the AUSF 2132 and the UE 2102 to perform various security anchor and context management functions. Furthermore, AMF 2134 may be a termination point of a RAN CP interface, which may include or be an N2 reference point between the RAN 2130 and the AMF 2134; and the AMF 2134 may be a termination point of NAS (N1) signaling, and perform NAS ciphering and integrity protection. AMF 2134 may also support NAS signaling with the UE 2102 over an N3 IWF interface.

The SMF 2136 may be responsible for SM (for example, session establishment, tunnel management between UPF 2138 and AN 2160); UE IP address allocation and management (including optional authorization); selection and control of UP function; configuring traffic steering at UPF 2138 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 2134 over N2 to AN 2160; and determining SSC mode of a session. SM may refer to management of a PDU session, and a PDU session or “session” may refer to a PDU connectivity service that provides or enables the exchange of PDUs between the UE 2102 and the data network 2122.

The UPF 2138 may act as an anchor point for intra-RAT and inter-RAT mobility, an external PDU session point of interconnect to data network 2122, and a branching point to support multi-homed PDU session. The UPF 2138 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 2138 may include an uplink classifier to support routing traffic flows to a data network.

The NSSF 2140 may select a set of network slice instances serving the UE 2102. The NSSF 2140 may also determine allowed NSSAI and the mapping to the subscribed S-NSSAIs, if needed. The NSSF 2140 may also determine the AMF set to be used to serve the UE 2102, or a list of candidate AMFs based on a suitable configuration and possibly by querying the NRF 2144. The selection of a set of network slice instances for the UE 2102 may be triggered by the AMF 2134 with which the UE 2102 is registered by interacting with the NSSF 2140, which may lead to a change of AMF. The NSSF 2140 may interact with the AMF 2134 via an N22 reference point; and may communicate with another NSSF in a visited network via an N31 reference point (not shown). Additionally, the NSSF 2140 may exhibit an Nnssf service-based interface.

The NEF 2142 may securely expose services and capabilities provided by 3GPP network functions for third party, internal exposure/re-exposure, AFs (e.g., AF 2150), edge computing or fog computing systems, etc. In such embodiments, the NEF 2142 may authenticate, authorize, or throttle the AFs. NEF 2142 may also translate information exchanged with the AF 2150 and information exchanged with internal network functions. For example, the NEF 2142 may translate between an AF-Service-Identifier and an internal 5GC information. NEF 2142 may also receive information from other NFs based on exposed capabilities of other NFs. This information may be stored at the NEF 2142 as structured data, or at a data storage NF using standardized interfaces. The stored information can then be re-exposed by the NEF 2142 to other NFs and AFs, or used for other purposes such as analytics. Additionally, the NEF 2142 may exhibit an Nnef service-based interface.

The NRF 2144 may support service discovery functions, receive NF discovery requests from NF instances, and provide the information of the discovered NF instances to the NF instances. NRF 2144 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 2144 may exhibit the Nnrf service-based interface.

The PCF 2146 may provide policy rules to control plane functions to enforce them, and may also support unified policy framework to govern network behavior. The PCF 2146 may also implement a front end to access subscription information relevant for policy decisions in a UDR of the UDM 2148. In addition to communicating with functions over reference points as shown, the PCF 2146 exhibit an Npcf service-based interface.

The UDM 2148 may handle subscription-related information to support the network entities' handling of communication sessions, and may store subscription data of UE 2102. For example, subscription data may be communicated via an N8 reference point between the UDM 2148 and the AMF 2134. The UDM 2148 may include two parts, an application front end and a UDR. The UDR may store subscription data and policy data for the UDM 2148 and the PCF 2146, and/or structured data for exposure and application data (including PFDs for application detection, application request information for multiple UEs 2102) for the NEF 2142. The Nudr service-based interface may be exhibited by the UDR 221 to allow the UDM 2148, PCF 2146, and NEF 2142 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 2148 may exhibit the Nudm service-based interface.

The AF 2150 may provide application influence on traffic routing, provide access to NEF, and interact with the policy framework for policy control.

In some embodiments, the 5GC 2152 may enable edge computing by selecting operator/3^{rd} party services to be geographically close to a point that the UE 2102 is attached to the network. This may reduce latency and load on the network. To provide edge-computing implementations, the 5GC 2152 may select a UPF 2138 close to the UE 2102 and execute traffic steering from the UPF 2138 to data network 2122 via the N6 interface. This may be based on the UE subscription data, UE location, and information provided by the AF 2150. In this way, the AF 2150 may influence UPF (re) selection and traffic routing. Based on operator deployment, when AF 2150 is considered to be a trusted entity, the network operator may permit AF 2150 to interact directly with relevant NFs. Additionally, the AF 2150 may exhibit a Naf service-based interface.

The data network 2122 may represent various network operator services, Internet access, or third party services that may be provided by one or more servers including, for example, application/content server 2120.

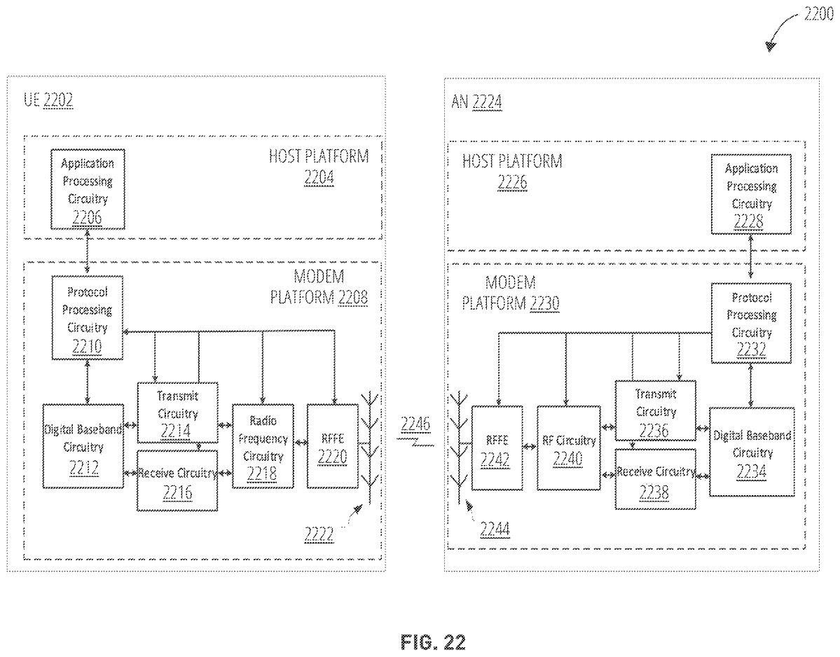

FIG. 22 schematically illustrates a wireless network 2200 in accordance with various embodiments. The wireless network 2200 may include a UE 2202 in wireless communication with an AN 2224. The UE 2202 and AN 2224 may be similar to, and substantially interchangeable with, like-named components described elsewhere herein.

The UE 2202 may be communicatively coupled with the AN 2224 via connection 2246. The connection 2246 is illustrated as an air interface to enable communicative coupling, and can be consistent with cellular communications protocols such as an LTE protocol or a 5G NR protocol operating at mmWave or sub-6 GHZ frequencies.

The UE 2202 may include a host platform 2204 coupled with a modem platform 2208. The host platform 2204 may include application processing circuitry 2206, which may be coupled with protocol processing circuitry 2210 of the modem platform 2208. The application processing circuitry 2206 may run various applications for the UE 2202 that source/sink application data. The application processing circuitry 2206 may further implement one or more layer operations to transmit/receive application data to/from a data network. These layer operations may include transport (for example UDP) and Internet (for example, IP) operations

The protocol processing circuitry 2210 may implement one or more of layer operations to facilitate transmission or reception of data over the connection 2246. The layer operations implemented by the protocol processing circuitry 2210 may include, for example, MAC, RLC, PDCP, RRC and NAS operations.

The modem platform 2208 may further include digital baseband circuitry 2212 that may implement one or more layer operations that are “below” layer operations performed by the protocol processing circuitry 2210 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 2208 may further include transmit circuitry 2214, receive circuitry 2216, RF circuitry 2218, and RF front end (RFFE) 2220, which may include or connect to one or more antenna panels 2222. Briefly, the transmit circuitry 2214 may include a digital-to-analog converter, mixer, intermediate frequency (IF) components, etc.; the receive circuitry 2216 may include an analog-to-digital converter, mixer, IF components, etc.; the RF circuitry 2218 may include a low-noise amplifier, a power amplifier, power tracking components, etc.; RFFE 2220 may include filters (for example, surface/bulk acoustic wave filters), switches, antenna tuners, beamforming components (for example, phase-array antenna components), etc. The selection and arrangement of the components of the transmit circuitry 2214, receive circuitry 2216, RF circuitry 2218, RFFE 2220, and antenna panels 2222 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 2210 may include one or more instances of control circuitry (not shown) to provide control functions for the transmit/receive components.

A UE reception may be established by and via the antenna panels 2222, RFFE 2220, RF circuitry 2218, receive circuitry 2216, digital baseband circuitry 2212, and protocol processing circuitry 2210. In some embodiments, the antenna panels 2222 may receive a transmission from the AN 2224 by receive-beamforming signals received by a plurality of antennas/antenna elements of the one or more antenna panels 2222.

A UE transmission may be established by and via the protocol processing circuitry 2210, digital baseband circuitry 2212, transmit circuitry 2214, RF circuitry 2218, RFFE 2220, and antenna panels 2222. In some embodiments, the transmit components of the UE 2224 may apply a spatial filter to the data to be transmitted to form a transmit beam emitted by the antenna elements of the antenna panels 2222.

Similar to the UE 2202, the AN 2224 may include a host platform 2226 coupled with a modem platform 2230. The host platform 2226 may include application processing circuitry 2228 coupled with protocol processing circuitry 2232 of the modem platform 2230. The modem platform may further include digital baseband circuitry 2234, transmit circuitry 2236, receive circuitry 2238, RF circuitry 2240, RFFE circuitry 2242, and antenna panels 2244. The components of the AN 2224 may be similar to and substantially interchangeable with like-named components of the UE 2202. In addition to performing data transmission/reception as described above, the components of the A 2204 may perform various logical functions that include, for example, RNC functions such as radio bearer management, uplink and downlink dynamic radio resource management, and data packet scheduling.

FIG. 23 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 23 shows a diagrammatic representation of hardware resources 2330 including one or more processors (or processor cores) 2310, one or more memory/storage devices 2322, and one or more communication resources 2326, each of which may be communicatively coupled via a bus 2320 or other interface circuitry. For embodiments where node virtualization (e.g., NFV) is utilized, a hypervisor 2302 may be executed to provide an execution environment for one or more network slices/sub-slices to utilize the hardware resources 2330.

The processors 2310 may include, for example, a processor 2312 and a processor 2314. The processors 2310 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2322 may include main memory, disk storage, or any suitable combination thereof. The memory/storage devices 2322 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2326 may include interconnection or network interface controllers, components, or other suitable devices to communicate with one or more peripheral devices 2304 or one or more databases 2306 or other network elements via a network 2308. For example, the communication resources 2326 may include wired communication components (e.g., for coupling via USB, Ethernet, etc.), cellular communication components, NFC components, Bluetooth® (or Bluetooth® Low Energy) components, Wi-Fi® components, and other communication components.

Instructions 106, 2318, 2324, 2328, 2332 may comprise software, a program, an application, an applet, an app, or other executable code for causing at least any of the processors 2310 to perform any one or more of the methodologies discussed herein. The instructions 106, 2318, 2324, 2328, 2332 may reside, completely or partially, within at least one of the processors 2310 (e.g., within the processor's cache memory), the memory/storage devices 2322, or any suitable combination thereof. Furthermore, any portion of the instructions 106, 2318, 2324, 2328, 2332 may be transferred to the hardware resources 2330 from any combination of the peripheral devices 2304 or the databases 2306. Accordingly, the memory of processors 2310, the memory/storage devices 2322, the peripheral devices 2304, and the databases 2306 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

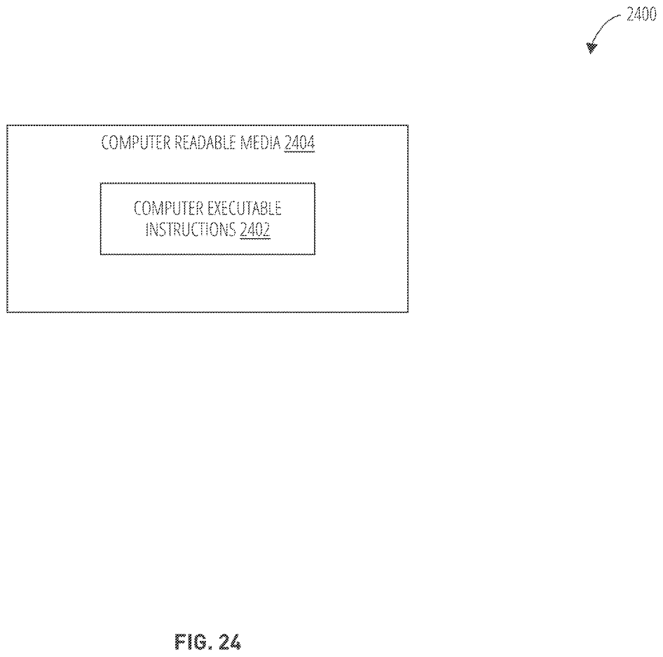

FIG. 24 illustrates computer readable storage medium 2400. Computer readable storage medium 2400 may comprise any non-transitory computer-readable storage medium or machine-readable storage medium, such as an optical, magnetic or semiconductor storage medium. In various embodiments, computer readable storage medium 2400 may comprise an article of manufacture. In some embodiments, computer readable storage medium 2400 may store computer executable instructions 2402 with which circuitry can execute. For example, computer executable instructions 2402 can include computer executable instructions 2402 to implement operations described with respect to logic flow 1100 and/or logic flow 1100. Examples of computer readable storage medium 2400 or machine-readable storage medium 2400 may include any tangible media capable of storing electronic data, including volatile memory or non-volatile memory, removable or non-removable memory, erasable or non-erasable memory, writeable or re-writeable memory, and so forth. Examples of computer executable instructions 2402 may include any suitable type of code, such as source code, compiled code, interpreted code, executable code, static code, dynamic code, object-oriented code, visual code, and the like.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The various elements of the devices as previously described with reference to FIGS. 1-24 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

The following examples pertain to further embodiments, from which numerous permutations and configurations will be apparent.

### Example Set 1

Example 1 may include an apparatus used in plurality of sensing entities wherein the apparatus comprises processor circuitries configured to cause the sensing entities to: map the [sensing] modulated symbols to time and frequency resources of an OFDM resource grid such that the spacing between subcarriers used for mapping of sensing modulated symbols within the total frequency span (sensing bandwidth), is such that the modulated symbols from each sensing entity are mapped to a different set of every m_{comb}-th subcarrier (i.e., each starting from a different subcarrier offset), and transmit the sensing modulated symbols.

Example 2 may include the apparatus of example 1 or some other example herein, wherein depending on the sensing environment, n takes values from the set {1, . . . ,6}, and m_{comb} takes values from the set {1, . . . ,4}.

Example 3 may include the apparatus of example 1 or some other example herein, wherein in a MIMO radar, different transmit antennas use the different comb resources.

Example 4 may include an apparatus used in a plurality of entities capable of performing sensing and communication, wherein the apparatus comprises processor circuitries configured to cause the sensing entities to: map the sensing modulated symbols to time and frequency resources of an Orthogonal Frequency Division Multiplexing (OFDM) resource grid such that modulated symbols are based on pseudo-random sequences and are generated such that

the sequence used for sensing signals from different entities are pseudo-orthogonal, and the sensing signal sequences used in one entity, and the scrambling sequences used for scrambling of different communication channels, used in other entities, are also pseudo-orthogonal.

Example 5 may include an apparatus used in a plurality of entities capable of performing sensing and communication, wherein the apparatus comprises processor circuitries configured to cause the sensing entities to:

map the modulated symbols to time and frequency resources of an Orthogonal Frequency Division Multiplexing (OFDM) resource grid such that the entities cooperatively separate their transmissions in one or more of time, frequency, sequence, spatial, and code domain, and transmit the modulated symbols.

Example 6 may include the apparatus of example 5 or some other example herein, wherein time domain separation of signals from different entities, is realized by muting of other entities' signal (sensing and/or communication signal, and at least in the directions interfering with the directions/FoV a given sensing BS needs to sense, which can be different if the entity is performing sensing based on its own transmitted radio signal (monostatic) or based on other entity's transmitted signal(s) (bi/multi-static)), for duration of one or multiple symbols, one or multiple sensing symbol repetition interval, sensing block duration, one or multiple slots, subframes or frames.

Example 7 may include the apparatus of example 5 or some other example herein, wherein the sensing entities map the sensing modulated symbols to time and frequency resources of an Orthogonal Frequency Division Multiplexing (OFDM) resource grid according to 5G NR Downlink (DL) Positioning Reference Signal (PRS) or an extended version of it, and the entity whose PRS is being muted, through proper coordination with other entities, would also mute its communication signal over same time resources (symbol(s) or slot(s)).

Example 8 may include the apparatus of example 5 or some other example herein, wherein the sensing entities map the sensing modulated symbols to time and frequency resources of an Orthogonal Frequency Division Multiplexing (OFDM) resource grid according to 5G NR Downlink (DL) Positioning Reference Signal (PRS) or an extended version of it, and Option 2 of DL-PRS muting is further extended, such that each PRS resource repetition in a PRS resource set instance, can be individually muted or transmitted.

Example 9 may include the apparatus of example 5 or some other example herein, wherein the sensing entities map the sensing modulated symbols to time and frequency resources of an Orthogonal Frequency Division Multiplexing (OFDM) resource grid according to 5G NR Downlink (DL) Positioning Reference Signal (PRS) or an extended version of it, and Option 2 of DL-PRS muting is further extended, such that for a multi-symbol PRS resource, each symbol within the resource or each intra-resource level repetition of PRS (if any), can be muted individually.

Example 10 may include the apparatus of example 5 or some other example herein, wherein the sensing entities map the sensing modulated symbols to time and frequency resources of an Orthogonal Frequency Division Multiplexing (OFDM) resource grid according to 5G NR Downlink (DL) Positioning Reference Signal (PRS) or an extended version of it, and muting parameters are defined as part of the PRS resource configuration (instead of the PRS resource set configuration).

Example 11 may include the apparatus of example 5 or some other example herein, wherein the sensing entities map the sensing modulated symbols to time and frequency resources of an Orthogonal Frequency Division Multiplexing (OFDM) resource grid according to 5G NR Downlink (DL) Positioning Reference Signal (PRS) or an extended version of it, and some or all muting-related configuration may be indicated or overrode via DL control channel (DCI).

Example 12 may include the apparatus of example 11 or some other example herein, wherein DCI indication may trigger and/or stop muting, at symbol and/or PRS resource and/or PRS resource set level.

Example 13 may include the apparatus of example 5 or some other example herein, wherein time domain separation via muting some transmission over certain time resources is realized through configuration of sensing measurement gaps in the interfering entities, where during the sensing measurement gaps, no transmission from the (interfering) entity (and potentially also from subset of UEs served by that entity) is scheduled, in directions affecting the sensing entity's' FoVs scanning.

Example 14 may include the apparatus of example 13 or some other example herein, wherein the sensing measurement gaps may overlap with existing measurement gaps supported in NR (intended for certain UE measurements, depending on UE capability), whenever possible.

Example 15 may include the apparatus of example 13 or some other example herein, wherein sensing measurement gap configuration also includes spatial-domain-related information, beside the time-domain-related indication (e.g., length, repetition, pattern), to increase the efficiency in resource usage. Accordingly, transmissions (from the entity's cell and potentially the devise covered in the cell) affecting the indicated spatial domain, may be avoided according to the time-domain configuration.

Example 16 may include the apparatus of example 6 or some other example herein, wherein muting of interfering entities applies to certain slots, and mutes sensing transmission and/or data transmission of the interfering entity(s) over those slots, such that slot-level time domain multiplexing between cell entities or between sections covered by the cell entities (e.g., corresponding to directions/FoVs which can cause direct interference) is achieved.

Example 17 may include the apparatus of example 6 or some other example herein, wherein muting of interfering entities applies to one or multiple OFDM symbol(s), and mutes sensing transmission and/or data transmission of the interfering entity(s) over such time resources, such that sub-slot-level time domain multiplexing between cell entities or between sections covered by the cell entities (e.g., corresponding to directions/FoVs which can cause direct interference) is achieved.

Example 18 may include the apparatus of example 6 or some other example herein, wherein for sensing beamforming implementations zero and non-zero power concept is used such that one beam at a time is powered and the others are empty. While one sensing and communication entity can use multiple beams with same physical layer settings, configures time and spatial resources in an alternating mapping such that for each sensing instance in time domain, only one of the beams has a non-zero power, and coordinates the beam transmissions accordingly.

Example 19 may include the apparatus of example 5 or some other example herein, wherein transmissions from different network entities are spatially separated, by separating the impact areas of signal reflections from targets in the FoVs of the sensing transmit beam(s) (the area over which a target can create a reflection that can cause interference to other entities, called interference FoV) between the network entities, and the network entities can use the same time and frequency resources to transmit beams outside the impact areas (interference FoVs).

Example 20 may include the apparatus of example 19 or some other example herein, wherein for each sensing transmit beam from a sensing network entity, the interference FoV is defined corresponding to each beam of each potentially interfering network entity, and as a function of geometry of the beams' FoVs as well as the reflected path of signals from targets in FoVs.

Example 21 may include the apparatus of example 20 or some other example herein, wherein the interference FoV area can be calculated assuming a maximum radar cross section (RCS) for a target (e.g., which may be falling at the far-end within a beam's transmit FoV) and applying the radar equation based on distance to TX and RX BS:

$${P}_{e} = \frac{{P}_{s} {G}_{1} {G}_{2} {λ}^{2} σ}{{( 4 π )}^{3} {r}_{1}^{2} {r}_{2}^{2}} ,$$

where Pₛ is transmit power, r1, and r2, are distances to the transmit and receive nodes, respectively, G₁, and G₂ are the antenna gains corresponding to TX and RX, respectively, λ is the signal wavelength, and σ is the radar cross section.

Example 22 may include the apparatus of examples 19-21 or some other example herein, wherein the network operator sets a (potentially non-zero) threshold on tolerable interference considering all the factors, such as the level of interference mitigation provided by using different codes for sensing signal in the two base stations, to determine the interference FoV.

Example 23 may include the apparatus of example 19-21 or some other example herein, wherein the interference FoV (for each beam direction) is calculated offline based on network topology information, the geometry, the cell and sectors mapping, and the orientation of antenna panels of base station(s) in the network.

Example 24 may include the apparatus of example 5 or example 19 or some other example herein, wherein orthogonal cover code (e.g., Hadamard code, or other random codes) are applied to the sensing signals and/or the communication signals from different entities.

Example 25 may include the apparatus of example 5 or example 19 or some other example herein, wherein the sensing symbols (e.g., across the sensing block duration) can be multiplied by a slow-time code or orthogonal cover code (e.g., with Hadamard code, or other random codes) and a random phase in time direction is introduced, where the random codes used for different entities are different.

Example 26 may include the apparatus of example 5 or example 19 or some other example herein, wherein sensing symbols use long code lengths of slow-time codes or orthogonal cover codes to increase the signal-to-noise ratio of the sensing signal while also increasing the orthogonality of the codes and reducing inter-cell interference.

Example 27 may include the apparatus of example 8 or some other example herein, wherein corresponding to each bit in the bitmap of DL-PRS Muting Pattern (dl-PRS-MutingPatternList-r16), another parameter is defined for each PRS resource within the set, to indicate whether the particular repetition of that PRS resource is transmitted or not.

Example 28 may include the apparatus of example 8 or some other example herein, wherein the size of the bitmap of DL-PRS Muting Pattern (dl-PRS-MutingPatternList-r16), (which can be {2, 4, 8, 16, 32} bits long) can be expanded by multiplying by the number of resources within a set, and the bitmap indicates transmission of each resource for a given repetition index, accordingly.

Example 29 may include the apparatus of example 9 or some other example herein, wherein a PRS resource configuration parameter (e.g., called dl-PRS-MutingPatternForResource), defines the symbol locations where part of the DL PRS resource is expected to not be transmitted.

Example 30 may include the apparatus of example 5 or some other example herein, wherein plurality of the signals separation schemes of examples 1-29 are configured either periodically, or triggered based on certain events such as obtaining certain measurements, or a combination of both.

Example 31 includes a method of a next-generation NodeB (gNB), comprising: identifying inter-cell interference with a neighboring gNB; receiving resource usage information associated with the neighboring gNB; and mapping, based on the resource usage information of the neighboring gNB, modulated symbols to time and frequency resources of an orthogonal frequency division multiplexing (OFDM) resource grid, wherein the mapped modulated symbols are to cooperatively separate transmissions of the gNB and the neighboring gNB in one or more of: a time domain, a frequency domain, a spatial domain, and a code domain.

Example 32 includes the method of example 31 or some other example herein, wherein the modulated symbols are mapped using frequency domain multiplexing through a comb structure.

Example 33 includes the method of example 31 or some other example herein, further comprising determining time-domain muting to mitigate the inter-cell interference with the neighboring gNB.

Example 34 includes the method of example 33 or some other example herein, wherein determining the time-domain muting is based on a number of sensing cells being larger than a maximum comb size.

Example 35 includes the method of example 31 or some other example herein, further comprising transmitting a message to a user equipment (UE) based on the mapping.

Example 36 includes the method of example 31 or some other example herein, further comprising sending a message to the neighboring gNB that includes an indication of the mapping.

Example 37 includes the method of example 31 or some other example herein, wherein mapping the modulated symbols is based on pseudo-random sequences.

Example 38 includes the method of example 31 or some other example herein, wherein mapping the modulated symbols is based on downlink (DL) positioning reference signal (PRS) information.

Example 39 includes the method of any of examples 31-38 or some other example herein, wherein the modulated symbols are associated with sensing signals.

### Example Set 2

In one example, an apparatus of a base station, the apparatus includes a memory interface to send or receive, to or from a data storage device, information for a wireless communications system. The apparatus also includes processor circuitry communicatively coupled to the memory interface, the processor circuitry to execute instructions for a sensing entity to map a first set of sensing modulated symbols to time and frequency resources of an orthogonal frequency division multiplexing (OFDM) resource grid, where the first set of sensing modulated symbols are mapped to a set of comb-structured subcarriers over one or more consecutive OFDM symbols to reduce interference with a second set of modulated symbols within a same frequency bandwidth, and encode a sensing signal includes the mapped first set of sensing modulated symbols.

The apparatus may also include the processor circuitry to decode a reflection signal based on the sensing signal, the reflection signal to comprise a reflection of the sensing signal from an object.

The apparatus of any preceding example may also include where the first set of sensing modulated symbols start from a different subcarrier offset than the second set of modulated symbols.

The apparatus of any preceding example may also include where the first set of sensing modulated symbols are associated with the sensing entity and the second set of modulated symbols are associated with a second entity, the second entity includes a base station.

The apparatus of any preceding example may also include radio-frequency (RF) circuitry communicatively coupled to the processor circuitry, the RF circuitry to transmit the encoded sensing signal and receive a reflection signal associated with the encoded sensing signal as RF signals. Other technical features may be readily apparent to one skilled in the art from the following figures, descriptions, and claims.

In one example, an apparatus of a sensing and communication entity, the apparatus includes a memory interface to send or receive, to or from a data storage device, information for a wireless communications system. The apparatus also includes processor circuitry communicatively coupled to the memory interface, the processor circuitry to execute instructions for a sensing entity to map a first set of sensing modulated symbols to time and frequency resources of an orthogonal frequency division multiplexing (OFDM) resource grid, where the first set of sensing modulated symbols are based on a pseudo-random (PN) sequence that is pseudo-orthogonal to a PN sequence used for a second set of modulated symbols, and encode a sensing signal includes the mapped first set of sensing modulated symbols.

The apparatus may also include where the PN sequence for the first set of sensing modulated signals is pseudo-orthogonal to a scrambling sequence used for the second set of modulated symbols, the scrambling sequence to scramble different communication channels.

The apparatus of any preceding example may also include where orthogonal cover codes are applied to the first set of sensing modulated symbols and the second set of modulated symbols.

The apparatus of any preceding example may also include where the first set of sensing modulated symbols and the second set of modulated symbols mapped across corresponding sensing block durations are multiplied by a slow-time code or orthogonal cover code, and where a random phase in a time domain is applied to the first set of sensing modulated symbols and the second set of modulated symbols. Other technical features may be readily apparent to one skilled in the art from the following figures, descriptions, and claims.

In one example, an apparatus of a sensing entity in a next-generation network, the apparatus includes a memory interface to send or receive, to or from a data storage device, information for a wireless communications system. The apparatus also includes processor circuitry communicatively coupled to the memory interface, the processor circuitry to execute instructions for a sensing entity to map sensing modulated symbols to time and frequency resources of an orthogonal frequency division multiplexing (OFDM) resource grid according to a new radio (NR) downlink (DL) positioning reference signal (PRS), where the DL-PRS configuration supports a time domain separation between a first modulated signal of the sensing entity and a second modulated signal of a second entity, the time domain separation realized by muting the second modulated signal for a duration of multiple symbols, multiple slots, or multiple subframes, and mute at least one of the DL PRS or a communication signal over a set of time resources.

The apparatus may also include where a configuration of the DL PRS supports each PRS resource repetition in a PRS resource set instance to be individually muted.

The apparatus may also include where a configuration of the DL PRS supports a subset of symbols in a multi-symbol PRS resource, or each intra-resource level repetition of PRS, to be muted while remaining symbols in the same multi-symbol PRS resource are transmitted.

The apparatus may also include where a set of muting parameters are defined as part of a PRS resource configuration.

The apparatus may also include where muting parameters are configured or overrode via a Downlink Control Information (DCI) channel.

The apparatus of any preceding example may also include the processor circuitry to mute slots or OFDM symbols and mutes sensing or data transmission of the second sensing entity, resulting in time domain multiplexing between cell entities or between sections covered by the second sensing entity.

The apparatus of any preceding example may also include a bitmap related to a DL-PRS Muting Pattern parameter, where corresponding to each bit in the bitmap of the DL-PRS Muting Pattern parameter, another parameter is defined for each PRS resource within the PRS resource set to indicate whether a repetition of the PRS resource is transmitted.

The apparatus of any preceding example may also include where the configuration of DL PRS further includes a bitmap where each bit in the bitmap indicates transmission of each resource for a given repetition index.

The apparatus of any preceding example may also include where a PRS resource configuration parameter such as dl-PRS-MutingPatternForResource, defines the symbol locations where part of the DL PRS resource is expected to not be transmitted.

The apparatus of any preceding example may also include the sensing entity further includes one or more sensing transmit beams, where impact areas of signal reflections of a target in a field of view (FoV) of the one or more sensing transmit beams are separated from second impact areas of the second entity. Other technical features may be readily apparent to one skilled in the art from the following figures, descriptions, and claims.

In one example, a method of a next-generation NodeB (gNB), includes identifying inter-cell interference with a neighboring gNB, receiving resource usage information associated with the neighboring gNB, and mapping, based on the resource usage information of the neighboring gNB, modulated symbols to time and frequency resources of an orthogonal frequency division multiplexing (OFDM) resource grid, where the mapped modulated symbols are to cooperatively separate transmissions of the gNB and the neighboring gNB in one or more of a time domain, a frequency domain, a spatial domain, or a code domain.

The method may also include where the modulated symbols are mapped using frequency domain multiplexing through a comb structure.

The method of any preceding example may also include determining time-domain muting to mitigate the inter-cell interference with the neighboring gNB. Other technical features may be readily apparent to one skilled in the art from the following figures, descriptions, and claims.

In one example, a method for a base station, includes mapping a first set of sensing modulated symbols to time and frequency resources of an orthogonal frequency division multiplexing (OFDM) resource grid, where the first set of sensing modulated symbols are mapped to a set of comb-structured subcarriers over one or more consecutive OFDM symbols to reduce interference with a second set of modulated symbols within a same frequency bandwidth, and encoding a sensing signal includes the mapped first set of sensing modulated symbols.

The method may also include decoding a reflection signal based on the sensing signal, the reflection signal to comprise a reflection of the sensing signal from an object.

The method of any preceding example may also include where the first set of sensing modulated symbols start from a different subcarrier offset than the second set of modulated symbols.

The method of any preceding example may also include where the first set of sensing modulated symbols are associated with the sensing entity and the second set of modulated symbols are associated with a second entity, the second entity includes a base station.

The method of any preceding example may also include transmitting the encoded sensing signal and receive a reflection signal associated with the encoded sensing signal as radio-frequency (RF) signals. Other technical features may be readily apparent to one skilled in the art from the following figures, descriptions, and claims.

In one example, a method of a sensing and communication entity, includes mapping a first set of sensing modulated symbols to time and frequency resources of an orthogonal frequency division multiplexing (OFDM) resource grid, where the first set of sensing modulated symbols are based on a pseudo-random (PN) sequence that is pseudo-orthogonal to a PN sequence used for a second set of modulated symbols, and encoding a sensing signal includes the mapped first set of sensing modulated symbols.

The method may also include where the PN sequence for the first set of sensing modulated signals is pseudo-orthogonal to a scrambling sequence used for the second set of modulated symbols, the scrambling sequence to scramble different communication channels.

The method of any preceding example may also include where orthogonal cover codes are applied to the first set of sensing modulated symbols and the second set of modulated symbols.

The method of any preceding example may also include where the first set of sensing modulated symbols and the second set of modulated symbols mapped across corresponding sensing block durations are multiplied by a slow-time code or orthogonal cover code, and where a random phase in a time domain is applied to the first set of sensing modulated symbols and the second set of modulated symbols. Other technical features may be readily apparent to one skilled in the art from the following figures, descriptions, and claims.

In one example, a method of a sensing entity in a next-generation network, includes mapping sensing modulated symbols to time and frequency resources of an orthogonal frequency division multiplexing (OFDM) resource grid according to a new radio (NR) downlink (DL) positioning reference signal (PRS), where the DL-PRS configuration supports a time domain separation between a first modulated signal of the sensing entity and a second modulated signal of a second entity, the time domain separation realized by muting the second modulated signal for a duration of multiple symbols, multiple slots, or multiple subframes, and muting at least one of the DL PRS or a communication signal over a set of time resources.

The method may also include where a configuration of the DL PRS supports each PRS resource repetition in a PRS resource set instance to be individually muted.

The method may also include where a configuration of the DL PRS supports a subset of symbols in a multi-symbol PRS resource, or each intra-resource level repetition of PRS, to be muted while remaining symbols in the same multi-symbol PRS resource are transmitted.

The method may also include where a set of muting parameters are defined as part of a PRS resource configuration.

The method may also include where muting parameters are configured or overrode via a Downlink Control Information (DCI) channel.

The method of any preceding example may also include muting slots or OFDM symbols and mutes sensing or data transmission of the second sensing entity, resulting in time domain multiplexing between cell entities or between sections covered by the second sensing entity.

The method of any preceding example may also include a bitmap related to a DL-PRS Muting Pattern parameter, where corresponding to each bit in the bitmap of the DL-PRS Muting Pattern parameter, another parameter is defined for each PRS resource within the PRS resource set to indicate whether a repetition of the PRS resource is transmitted.

The method of any preceding example may also include to claim 42, where the configuration of DL PRS further includes a bitmap where each bit in the bitmap indicates transmission of each resource for a given repetition index.

The method of any preceding example may also include where a PRS resource configuration parameter such as dl-PRS-MutingPatternForResource, defines the symbol locations where part of the DL PRS resource is expected to not be transmitted.

The method of any preceding example may also include transmitting one or more sensing transmit beams, where impact areas of signal reflections of a target in a field of view (FoV) of the one or more sensing transmit beams are separated from second impact areas of the second entity. Other technical features may be readily apparent to one skilled in the art from the following figures, descriptions, and claims.

In one example, an apparatus of a next-generation NodeB (gNB), includes a memory interface to send or receive, to or from a data storage device, information for a wireless communications system. The apparatus also includes processor circuitry communicatively coupled to the memory interface, the processor circuitry to execute instructions for a sensing entity to identify inter-cell interference with a neighboring gNB, receive resource usage information associated with the neighboring gNB, and map, based on the resource usage information of the neighboring gNB, modulated symbols to time and frequency resources of an orthogonal frequency division multiplexing (OFDM) resource grid, where the mapped modulated symbols are to cooperatively separate transmissions of the gNB and the neighboring gNB in one or more of a time domain, a frequency domain, a spatial domain, or a code domain.

The apparatus may also include where the modulated symbols are mapped using frequency domain multiplexing through a comb structure.

The apparatus of any preceding example may also include determining time-domain muting to mitigate the inter-cell interference with the neighboring gNB. Other technical features may be readily apparent to one skilled in the art from the following figures, descriptions, and claims.

In one example, a non-transitory computer-readable storage medium, the computer-readable storage medium including instructions that when executed by a computer, cause the computer to identify inter-cell interference with a neighboring gNB, receive resource usage information associated with the neighboring gNB, and map, based on the resource usage information of the neighboring gNB, modulated symbols to time and frequency resources of an orthogonal frequency division multiplexing (OFDM) resource grid, where the mapped modulated symbols are to cooperatively separate transmissions of the gNB and the neighboring gNB in one or more of a time domain, a frequency domain, a spatial domain, or a code domain.

The computer-readable storage medium may also include where the modulated symbols are mapped using frequency domain multiplexing through a comb structure.

The computer-readable storage medium may also include determine time-domain muting to mitigate the inter-cell interference with the neighboring gNB. Other technical features may be readily apparent to one skilled in the art from the following figures, descriptions, and claims.

In one example, a non-transitory computer-readable storage medium, the computer-readable storage medium including instructions that when executed by a computer, cause the computer to map a first set of sensing modulated symbols to time and frequency resources of an orthogonal frequency division multiplexing (OFDM) resource grid, where the first set of sensing modulated symbols are mapped to a set of comb-structured subcarriers over one or more consecutive OFDM symbols to reduce interference with a second set of modulated symbols within a same frequency bandwidth, and encode a sensing signal includes the mapped first set of sensing modulated symbols.

The computer-readable storage medium may also include decode a reflection signal based on the sensing signal, the reflection signal to comprise a reflection of the sensing signal from an object.

The computer-readable storage medium may also include where the first set of sensing modulated symbols start from a different subcarrier offset than the second set of modulated symbols.

The computer-readable storage medium may also include where the first set of sensing modulated symbols are associated with the sensing entity and the second set of modulated symbols are associated with a second entity, the second entity includes a base station.

The computer-readable storage medium may also include transmit the encoded sensing signal and receive a reflection signal associated with the encoded sensing signal as radio-frequency (RF) signals. Other technical features may be readily apparent to one skilled in the art from the following figures, descriptions, and claims.

In one example, a non-transitory computer-readable storage medium, the computer-readable storage medium including instructions that when executed by a computer, cause the computer to map a first set of sensing modulated symbols to time and frequency resources of an orthogonal frequency division multiplexing (OFDM) resource grid, where the first set of sensing modulated symbols are based on a pseudo-random (PN) sequence that is pseudo-orthogonal to a PN sequence used for a second set of modulated symbols, and encode a sensing signal includes the mapped first set of sensing modulated symbols.

The computer-readable storage medium may also include where the PN sequence for the first set of sensing modulated signals is pseudo-orthogonal to a scrambling sequence used for the second set of modulated symbols, the scrambling sequence to scramble different communication channels.

The computer-readable storage medium may also include where orthogonal cover codes are applied to the first set of sensing modulated symbols and the second set of modulated symbols.

The computer-readable storage medium may also include where the first set of sensing modulated symbols and the second set of modulated symbols mapped across corresponding sens block durations are multiplied by a slow-time code or orthogonal cover code, and where a random phase in a time domain is applied to the first set of sensing modulated symbols and the second set of modulated symbols. Other technical features may be readily apparent to one skilled in the art from the following figures, descriptions, and claims.

In one example, a non-transitory computer-readable storage medium, the computer-readable storage medium including instructions that when executed by a computer, cause the computer to identify inter-cell interference with a neighboring gNB, receive resource usage information associated with the neighboring gNB, and map, based on the resource usage information of the neighboring gNB, modulated symbols to time and frequency resources of an orthogonal frequency division multiplexing (OFDM) resource grid, where the mapped modulated symbols are to cooperatively separate transmissions of the gNB and the neighboring gNB in one or more of a time domain, a frequency domain, a spatial domain, or a code domain.

The computer-readable storage medium may also include where the modulated symbols are mapped using frequency domain multiplexing through a comb structure.

The computer-readable storage medium may also include determine time-domain muting to mitigate the inter-cell interference with the neighboring gNB. Other technical features may be readily apparent to one skilled in the art from the following figures, descriptions, and claims.

The apparatus may also include the processor circuitry to analyze the reflection signal to determine an identity of the object, a location of the object, a range of the object, an angle of the object, or a velocity of the object.

The apparatus may also include where the DCI channel indicates at least one of the initiation or the cessation of the muting operation.

The method may also include where the time-domain muting is based on a number of sensing cells being larger than a maximum comb size.

The method may also include where mapping the modulated symbols is based on downlink (DL) positioning reference signal (PRS) information.

The method may also include analyzing the reflection signal to determine an identity of the object, a location of the object, a range of the object, an angle of the object, or a velocity of the object.

The method may also include where the DCI channel indicates at least one of the initiation or the cessation of the muting operation.

The apparatus may also include where the time-domain muting is based on a number of sensing cells being larger than a maximum comb size.

The apparatus may also include where map the modulated symbols is based on downlink (DL) positioning reference signal (PRS) information.

The computer-readable storage medium may also include where the time-domain mute is based on a number of sensing cells being larger than a maximum comb size.

The computer-readable storage medium may also include where mapping the modulated symbols is based on downlink (DL) position reference signal (PRS) information.

The computer-readable storage medium may also include analyze the reflection signal to determine an identity of the object, a location of the object, a range of the object, an angle of the object, or a velocity of the object.

The computer-readable storage medium may also include where the time-domain mute is based on a number of sensing cells being larger than a maximum comb size.

The computer-readable storage medium may also include where mapping the modulated symbols is based on downlink (DL) position reference signal (PRS) information.

Other technical features may be readily apparent to one skilled in the art from the following figures, descriptions, and claims.

1-20. (canceled)

21. An apparatus of a base station, the apparatus comprising:
a memory interface to send or receive, to or from a data storage device, information for a wireless communications system; and
processor circuitry communicatively coupled to the memory interface, the processor circuitry to execute instructions for a sensing entity to:
map a first set of sensing modulated symbols to time and frequency resources of an orthogonal frequency division multiplexing (OFDM) resource grid, wherein the first set of sensing modulated symbols are mapped to a set of comb-structured subcarriers over one or more consecutive OFDM symbols to reduce interference with a second set of modulated symbols within a same frequency bandwidth; and
encode a sensing signal comprising the mapped first set of sensing modulated symbols.

22. The apparatus of claim 21, the processor circuitry to decode a reflection signal based on the sensing signal, the reflection signal to comprise a reflection of the sensing signal from an object.

23. The apparatus of claim 22, the processor circuitry to analyze the reflection signal to determine an identity of the object, a location of the object, a range of the object, an angle of the object, or a velocity of the object.

24. The apparatus of claim 21, wherein the first set of sensing modulated symbols start from a different subcarrier offset than the second set of modulated symbols.

25. The apparatus of claim 21, wherein the first set of sensing modulated symbols are associated with the sensing entity and the second set of modulated symbols are associated with a second entity, the second entity comprising a base station.

26. The apparatus of claim 21, comprising radio-frequency (RF) circuitry communicatively coupled to the processor circuitry, the RF circuitry to transmit the encoded sensing signal and receive a reflection signal associated with the encoded sensing signal as RF signals.

27. An apparatus, comprising:
a memory interface to send or receive, to or from a data storage device, information for a wireless communications system; and
processor circuitry communicatively coupled to the memory interface, the processor circuitry to execute instructions for a sensing entity to:
map a first set of sensing modulated symbols to time and frequency resources of an orthogonal frequency division multiplexing (OFDM) resource grid, wherein the first set of sensing modulated symbols are based on a pseudo-random (PN) sequence that is pseudo-orthogonal to a PN sequence used for a second set of modulated symbols; and
encode a sensing signal comprising the mapped first set of sensing modulated symbols.

28. The apparatus of claim 27, wherein the PN sequence for the first set of sensing modulated signals is pseudo-orthogonal to a scrambling sequence used for the second set of modulated symbols, the scrambling sequence to scramble different communication channels.

29. The apparatus of claim 27, wherein orthogonal cover codes are applied to the first set of sensing modulated symbols and the second set of modulated symbols.

30. The apparatus of claim 27, wherein the first set of sensing modulated symbols and the second set of modulated symbols mapped across corresponding sensing block durations are multiplied by a slow-time code or orthogonal cover code, and wherein a random phase in a time domain is applied to the first set of sensing modulated symbols and the second set of modulated symbols.

31. An apparatus, comprising:
a memory interface to send or receive, to or from a data storage device, information for a wireless communications system; and
processor circuitry communicatively coupled to the memory interface, the processor circuitry to execute instructions for a sensing entity to:
map sensing modulated symbols to time and frequency resources of an orthogonal frequency division multiplexing (OFDM) resource grid according to a new radio (NR) downlink (DL) positioning reference signal (PRS), where the DL-PRS configuration supports a time domain separation between a first modulated signal of the sensing entity and a second modulated signal of a second entity, the time domain separation realized by muting the second modulated signal for a duration of multiple symbols, multiple slots, or multiple subframes; and
mute at least one of the DL PRS or a communication signal over a set of time resources.

32. The apparatus of claim 31, wherein a configuration of the DL PRS supports each PRS resource repetition in a PRS resource set instance to be individually muted.

33. The apparatus of claim 31, wherein a configuration of the DL PRS supports a subset of symbols in a multi-symbol PRS resource, or each intra-resource level repetition of PRS, to be muted while remaining symbols in the same multi-symbol PRS resource are transmitted.

34. The apparatus of claim 31, wherein a set of muting parameters are defined as part of a PRS resource configuration.

35. The apparatus of claim 31, wherein muting parameters are configured or overrode via a Downlink Control Information (DCI) channel.

36. The apparatus of claim 35, wherein the DCI channel indicates at least one of the initiation or the cessation of the muting operation.

37. The apparatus of claim 31, the processor circuitry to mute slots or OFDM symbols and mutes sensing or data transmission of the second sensing entity, resulting in time domain multiplexing between cell entities or between sections covered by the second sensing entity.

38. The apparatus of claim 31, further comprising a bitmap related to a DL-PRS Muting Pattern parameter, wherein corresponding to each bit in the bitmap of the DL-PRS Muting Pattern parameter, another parameter is defined for each PRS resource within the PRS resource set to indicate whether a repetition of the PRS resource is transmitted.

39. The apparatus of claim 31, wherein the configuration of DL PRS further comprises a bitmap where each bit in the bitmap indicates transmission of each resource for a given repetition index.

40. The apparatus of claim 31, wherein a PRS resource configuration parameter such as dl-PRS-MutingPatternForResource, defines the symbol locations where part of the DL PRS resource is expected to not be transmitted.
